(19) United States
(12) Patent Application Publication
(10) Pub. No.: US 2013/0178175 A1
(43) Pub. Date: Jul. 11, 2013

(54) VOLTAGE STANDING WAVE RATIO DETECTION CIRCUIT

(71) Applicant: FUJITSU LIMITED, Kawasaki-shi (JP)

(72) Inventor: Atsushi Kato, Yokosuka (JP)

(73) Assignee: FUJITSU LIMITED, Kawasaki-shi (JP)

(21) Appl. No.: 13/735,705

(22) Filed: Jan. 7, 2013

(30) Foreign Application Priority Data
Jan. 11, 2012 (JP) 2012-003437

(51) Int. Cl. H04B 7/005

(52) U.S. Cl. CPC H04B 7/005
USPC 455/107

(57) ABSTRACT

There is provided a voltage standing wave ratio detection circuit which includes a filter that limits a frequency of a transmission wave, a detection circuit that detects a reflected wave of the transmission wave, the transmission wave being reflected from a load connected in a later stage of the filter and having passed through the filter, a storage device that stores correction information on the basis of a reflected wave generated at a time which a reference load has been connected in the later stage of the filter, and an arithmetic circuit that corrects a voltage standing wave ratio calculated on the basis of the reflected wave and the transmission wave by correcting the reflected wave detected by the detection circuit on the basis of the correction information.

### CROSS-REFERENCE TO RELATED APPLICATION

This application is based upon and claims the benefit of priority of the prior Japanese Patent Application No. 2012-003437, filed on Jan. 11, 2012, the entire contents of which are incorporated herein by reference.

### FIELD

The embodiment discussed herein is related to a voltage standing wave ratio (VSWR) detection circuit.

### BACKGROUND

In a wireless communication apparatus that transmits high-frequency signals, such as a mobile phone, it is desirable in terms of efficient transmission of the signals that the impedance of the wireless communication apparatus and the impedance of external connection devices (transmission load) connected to the wireless communication apparatus, such as a power supply cable, a connector, and an antenna, match. “Impedance matching” refers to matching of the output impedance of a circuit that transmits a signal and the input impedance of a circuit that receives the signal. For example, the impedance matching is typified by matching of the characteristic impedance of the wireless communication apparatus and the characteristic impedance of the transmission load. When the wireless communication apparatus and the transmission load match, a desired maximum output may be obtained in the wireless communication apparatus, and generation of a reflected wave at a mismatch point may be suppressed.

In general, the wireless communication apparatus is operated after matching between the wireless communication apparatus and the transmission load is confirmed, and therefore efficient transmission is possible in the wireless communication apparatus. However, during the operation, failures might occur in the transmission load, such as deterioration of the transmission load due to aging and the like and physical damage to the transmission load due to hurricanes, lightning, earthquakes, and the like. Thus, if a failure occurs in the transmission load, the impedance of the transmission load changes, and accordingly a mismatch is caused between the transmission load and the wireless communication apparatus. Therefore, the transmission power of the antenna and the reception power of the antenna decrease, thereby causing a problem in that the performance of a wireless communication system deteriorates. In addition, in a high-frequency circuit, a reflected wave is generated at a mismatch point and superimposed upon a traveling wave to form a standing wave, which causes a problem in that inconvenience such as radio wave interference occurs.

In order to avoid such a situation and to secure the reliability of the system, the wireless communication apparatus desirably has a VSWR detection function for monitoring failures in the transmission load.

A VSWR is a ratio of a maximum value of the voltage of a standing wave to a minimum value of the voltage of the standing wave, in which a traveling wave, which is a component of a transmission signal in a traveling direction, and a reflected wave, which travels along a transmission path in an opposite direction to that of the traveling wave, are combined. The VSWR may be obtained, for example, by the following expression (1).

$$V S W R = \frac{{V}_{max}}{{V}_{min}} = \frac{\vert {V}_{f} \vert + \vert {V}_{r} \vert}{\vert {V}_{f} \vert - \vert {V}_{r} \vert} \geq 1.0 , ( \vert {V}_{f} \vert \geq \vert {V}_{r} \vert ) \qquad ( 1 )$$

Vₘₐₓ: Maximum value of voltage of standing wave

Vₘᵢₙ: Minimum value of voltage of standing wave

V_{f}: Voltage of traveling wave

Vᵣ: Voltage of reflected wave

When the wireless communication apparatus and the transmission load completely match, no reflected wave is generated, and the voltage of the reflected wave (Vᵣ) is 0. From the expression (1), the VSWR becomes 1.0, which is the minimum value possible for the VSWR. On the other hand, when there is a mismatch between the wireless communication apparatus and the transmission load, a reflected wave is generated, and from the expression (1), the VSWR becomes larger than 1.0. Therefore, by detecting the VSWR, a mismatch state of the wireless communication apparatus and the transmission load, that is, a failure in the transmission load, may be detected.

A return loss (RL) is another concept that expresses load matching. The return loss refers to a reflection loss and indicates a ratio of reflection power (the power of a reflected wave) to input power (the power of a traveling wave) in a port of a high-frequency circuit. The return loss (unit dB) may be obtained, for example, by the following expression (2).

$$R L ( dB ) = - 20 \times LOG \frac{\vert {V}_{r} \vert}{\vert {V}_{f} \vert} = Fwd - Rev \geq 0 , ( 0 \leq \frac{\vert {V}_{r} \vert}{\vert {V}_{f} \vert} \leq 1 ) \qquad ( 2 )$$

V_{f}: Voltage of traveling wave (V)

Vᵣ: Voltage of reflected wave (V)

Fwd: Power of traveling wave (dB)

Rev: Power of reflected wave (dB)

As the return loss becomes larger, matching is more complete. For example, when a return loss calculated from the expression (2) is 20 dB, the level of the reflected wave is lower than the level of the traveling wave by 20 dB. It is to be noted that the return loss may be calculated by an expression obtained by deleting the minus sign from the above expression (2), that is, an expression that produces a return loss lower than or equal to 0. FIG. 12 illustrates the characteristics of a return loss calculated by an expression obtained by deleting the minus sign from the expression (2). For example, the return loss is obtained by the expression (2) herein.

From the expressions (1) and (2), the following expression is obtained.

$$R L ( dB ) = 20 \times log ( \frac{V S W R + 1}{V S W R - 1} )$$

Therefore, the VSWR and the RL are equivalent (for example, in perfect matching where the VSWR is 1, the RL is ∞).

In order to accurately detect a failure in the transmission load, it is desirable in the VSWR detection function that the VSWR is accurately detected (measured). As a method for improving the measurement accuracy of the VSWR, for example, a method in which interference between the traveling wave and the reflected wave is suppressed may be used. Various techniques for realizing the method in which interference is suppressed are known. For example, a technique is known in which the VSWR is accurately measured by measuring the voltages of the traveling wave and the reflected wave while isolating the path of the reflected wave from that of the traveling wave using a circulator and by detecting the reflected wave and the traveling wave (for example, Japanese Laid-open Patent Publication No. 2002-43957). In addition, a technique is known in which, even if the reflected wave includes the leakage power of the traveling wave, the VSWR is accurately measured by removing the leakage power component of the traveling wave using a vector adjuster and by measuring only the reflected wave (for example, Japanese Laid-open Patent Publication No. 2004-286632). In addition, a technique is known in which the level of the traveling wave and the level of the reflected wave that do not include leakage components are obtained by adjusting the relative phase difference between the reflected wave and the leakage component of the traveling wave and the relative phase difference between the traveling wave and the leakage component of the reflected wave using a variable phase shifter, and then the VSWR is calculated (for example, Japanese Laid-open Patent Publication No. 2005-17138).

### SUMMARY

According to an aspect of the invention, a voltage standing wave ratio detection circuit includes a filter that limits a frequency of a transmission wave, a detection circuit that detects a reflected wave of the transmission wave, where the transmission wave is reflected from a load connected in a later stage of the filter and has passed through the filter, a storage device that stores correction information on the basis of a reflected wave generated at a time which a reference load has been connected in the later stage of the filter, and an arithmetic circuit that corrects a voltage standing wave ratio calculated on the basis of the reflected wave and the transmission wave by correcting the reflected wave detected by the detection circuit on the basis of the correction information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the hardware configuration of a wireless communication apparatus including a VSWR detection circuit according to a first example;

FIG. 2 is a diagram illustrating an example of correction information (correction tables) according to the first example;

FIG. 3 is a diagram illustrating an example of a state in which a reference load has been connected to the wireless communication apparatus according to the first example;

FIG. 4 is a diagram illustrating an example of the generation flow of the correction information according to the first example;

FIG. 5 is a diagram illustrating the calculation flow of a VSWR according to the first example;

FIG. 6 is a diagram illustrating the flow of a correction value determination process according to the first example;

FIG. 7 is a diagram illustrating the flow of a correction value determination process according to a second example;

FIG. 8 is a diagram illustrating the flow of a correction value determination process according to a third example;

FIG. 9 is a diagram illustrating an example of correction information (correction tables) according to a fourth example;

FIG. 10 is a diagram illustrating an example of the flow of a correction value determination process according to the fourth example;

FIG. 11 is a diagram illustrating an example of the correction information (correction tables) according to the fourth example;

FIG. 12 is a diagram illustrating an example of the return loss characteristics of a filter;

FIG. 13 is a diagram illustrating an example of the return loss characteristics of the filter; and

FIG. 14 is a diagram illustrating an example of the return loss characteristics of the filter.

### DESCRIPTION OF EMBODIMENTS

Preliminary Consideration

Because the wireless communication apparatus does not transmit nor receive a signal having an unnecessary frequency outside a certain range, the wireless communication apparatus generally includes a band-pass filter (BPF). In this case, even if the interference between the traveling wave and the reflected wave is suppressed, a variation in the power of the reflected wave is undesirably generated when the phase of the transmission load has changed while the wireless communication apparatus is detecting the reflected wave that has passed through the filter, because the return loss characteristics of the filter have ripples. In this case, there is a problem in that a measurement error is caused in the VSWR due to the variation in the power of the reflected wave (hereinafter referred to as the level of the reflected wave) detected.

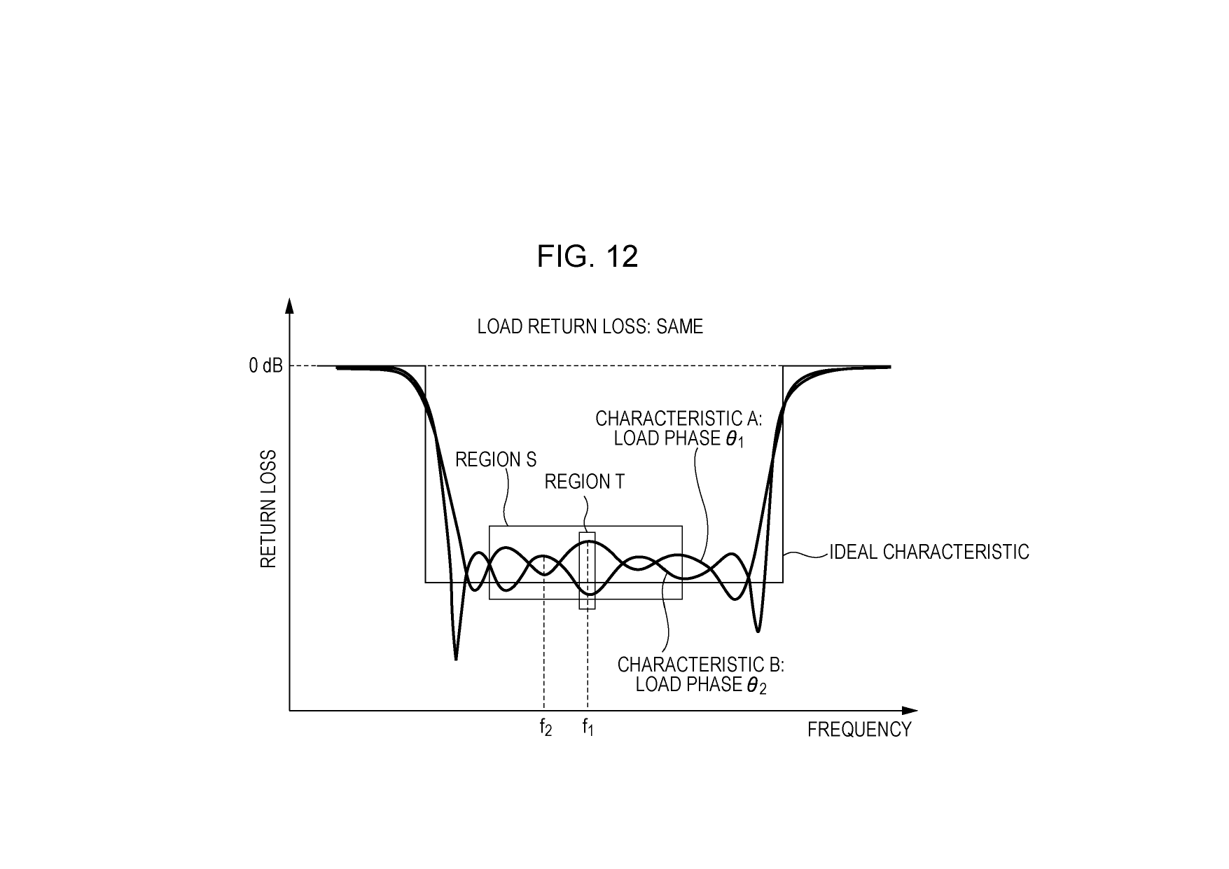

FIG. 12 is a diagram illustrating an example of the return loss characteristics of the filter. In FIG. 12, the horizontal axis represents the frequency of the wireless communication apparatus, and the vertical axis represents return loss. The word “frequency” simply used in the following description will refer to the “frequency of the wireless communication apparatus”. FIG. 12 illustrates the return loss characteristics (a characteristic A and a characteristic B) of the filter at a time when transmission loads whose return losses are the same but whose phases are different, namely θ1 and θ2, respectively, are connected. The return loss of a load will be referred to as the “load return loss” and the phase of a load will be referred to as the “load phase” hereinafter. FIG. 12 also illustrates an ideal characteristic at a time when a transmission load having the same return loss as the transmission loads having the characteristics A and B, respectively, is connected.

Because a filter generally has the configuration of a multistage resonator or the like, the return loss characteristics of the filter indicate characteristics having ripples according to a plurality of poles, such as the characteristics A and B illustrated in FIG. 12, that is, the ripple characteristics. Therefore, the return loss characteristics of the filter are generally not flat frequency characteristics like the ideal characteristic illustrated in FIG. 12. In addition, as indicated by the characteristics A and B illustrated in FIG. 12, even if the load return losses are the same, the return loss characteristics of the filter are different when the load phases are different (θ1 and θ2). That is, the return loss characteristics of the filter vary depending on the phase of the load.

When the reflected wave has been detected without passing through the filter, the detected level of the reflected wave does not vary only if the load return losses are the same even when the load phase of the transmission load has changed. As a result, the obtained VSWRs are the same. However, as described above, when the reflected wave has been detected after passing through the filter, the return loss characteristics of the filter are different if the load phases are different even when the load return losses are the same. Therefore, even if the load return losses are the same, the level of the reflected wave becomes different between transmission loads whose load phases are different, and, as a result, the obtained VSWRs are different.

For example, at a frequency f₁ illustrated in FIG. 12, the return loss of the filter is small when the load phase is θ1 (in the case of the characteristic A) and the return loss of the filter is large when the load phase is θ2 (in the case of the characteristic B). Therefore, in the case of the characteristic A, the detected level of the reflected wave is large compared to the case of the characteristic B.

Therefore, the technique disclosed herein aims to improve the measurement accuracy of the VSWR by correcting a variation in the level of the reflected wave generated due to the ripple characteristics of the filter.

A VSWR detection circuit according to an embodiment will be described hereinafter with reference to the drawings. Configurations according to the following examples are merely examples, and the VSWR detection circuit according to the embodiment is not limited to the configurations according to these examples.

### First Example

A VSWR detection circuit according to a first example accurately measures a VSWR by correcting the amount of variation in the level of a reflected wave that has passed through a filter, the amount of variation being generated due to the ripple characteristics of the filter. Originally, the level of a reflected wave is, as indicated by the expression (2), a level (hereinafter referred to as the “reference level”) obtained by subtracting a load return loss from the power level of a traveling wave. The “amount of variation in the level of a reflected wave” refers to the amount of variation from the reference level, that is, a difference from the reference level, generated due to the ripple characteristics of the filter when the load phase is different. “Correcting the amount of variation in the level of a reflected wave” refers to correcting the detected level of a reflected wave such that the detected level of the reflected wave becomes the reference level. It is to be noted that “correcting the amount of variation in the level of a reflected wave” means that the amount of variation in return loss (VSWR) is corrected. The “amount of variation in return loss” refers to a difference between an actual return loss that has been detected and the load return loss.

As illustrated in FIG. 12, when the load phase is different, the return loss characteristics of the filter, that is, the detected level of the reflected wave, is different, but there is a certain correspondence between the return loss characteristics of the filter and the load phase.

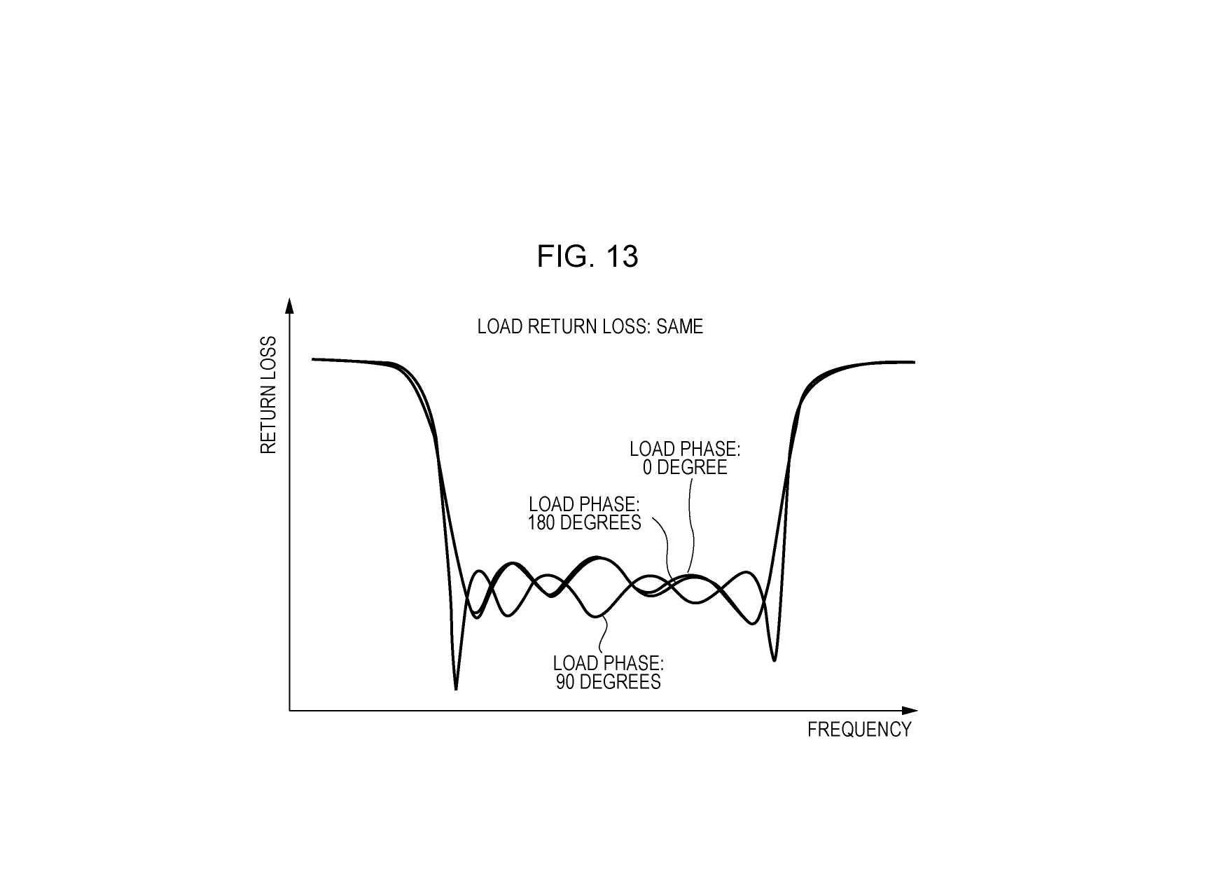

FIG. 13 is a diagram illustrating an example of the return loss characteristics of the filter. In FIG. 13, the horizontal axis represents frequency, and the vertical axis represents return loss. FIG. 13 illustrates return loss characteristics at times when the load phase is 0 degree, 90 degrees, and 180 degrees, respectively, and the load return loss does not vary (remains the same). As illustrated in FIG. 13, the return loss characteristics when the load phase is 0 degree and when the load phase is 180 degrees are substantially the same. In addition, as illustrated in FIG. 13, the return loss characteristics when the load phase is 90 degrees are characteristics obtained by shifting the phase of the return loss characteristics at a time when the load phase is 0 degree (180 degrees) by 180 degrees.

Thus, since there is a certain correspondence between the return loss characteristics and the load phase, it is possible to correct the return loss by storing the correspondence between the return loss characteristics and the load phase in advance and by using a load phase detected during the operation of a wireless communication apparatus 100 and the correspondence.

For example, by connecting, to the wireless communication apparatus, reference loads whose load phases are known and by obtaining the amount of variation in the level of the reflected wave corresponding to each load phase in advance, the level of the reflected wave may be corrected using one of the obtained amounts of variation in the level of the reflected wave if the load phase when a transmission load is actually connected may be detected. In this example, the phase of the reflected wave corresponding to each load phase is detected instead of detecting the load phase. In addition, in this example, the amount of variation in return loss is used instead of the amount of variation in the level of the reflected wave. That is, in this example, a plurality of reference loads whose load phases and load return losses are known are connected to the wireless communication apparatus 100 as dummy loads, and the phase of the reflected wave and the amount of variation in return loss corresponding to the phase of a reflected wave are obtained in advance for each reference load. Thereafter, by correcting the level of the reflected wave (return loss) on the basis of the phase of the reflected wave detected when a transmission load is actually connected and the amounts of variation in return loss obtained in advance, the VSWR is corrected (calculated). The phases of the reflected wave and the amounts of variation in return loss corresponding to the phases of the reflected wave obtained in advance are stored in the wireless communication apparatus 100 as correction information, which will be described later.

Here, as illustrated in FIG. 12, when the frequency is different, the level of the reflected wave detected is different even when the load return loss and the load phase are the same. For example, at a frequency f₁ illustrated in FIG. 12, the level of the reflected wave is higher when the load phase is θ₁ than when the load phase is θ₂. On the other hand, at a frequency f₂, an inverse relationship is established between the two, that is, the level of the reflected wave is higher when the load phase is θ₂ than when the load phase is θ₁.

Furthermore, when the load return loss has changed, the level of the reflected wave detected and the amount of variation in the level of the reflected wave change.

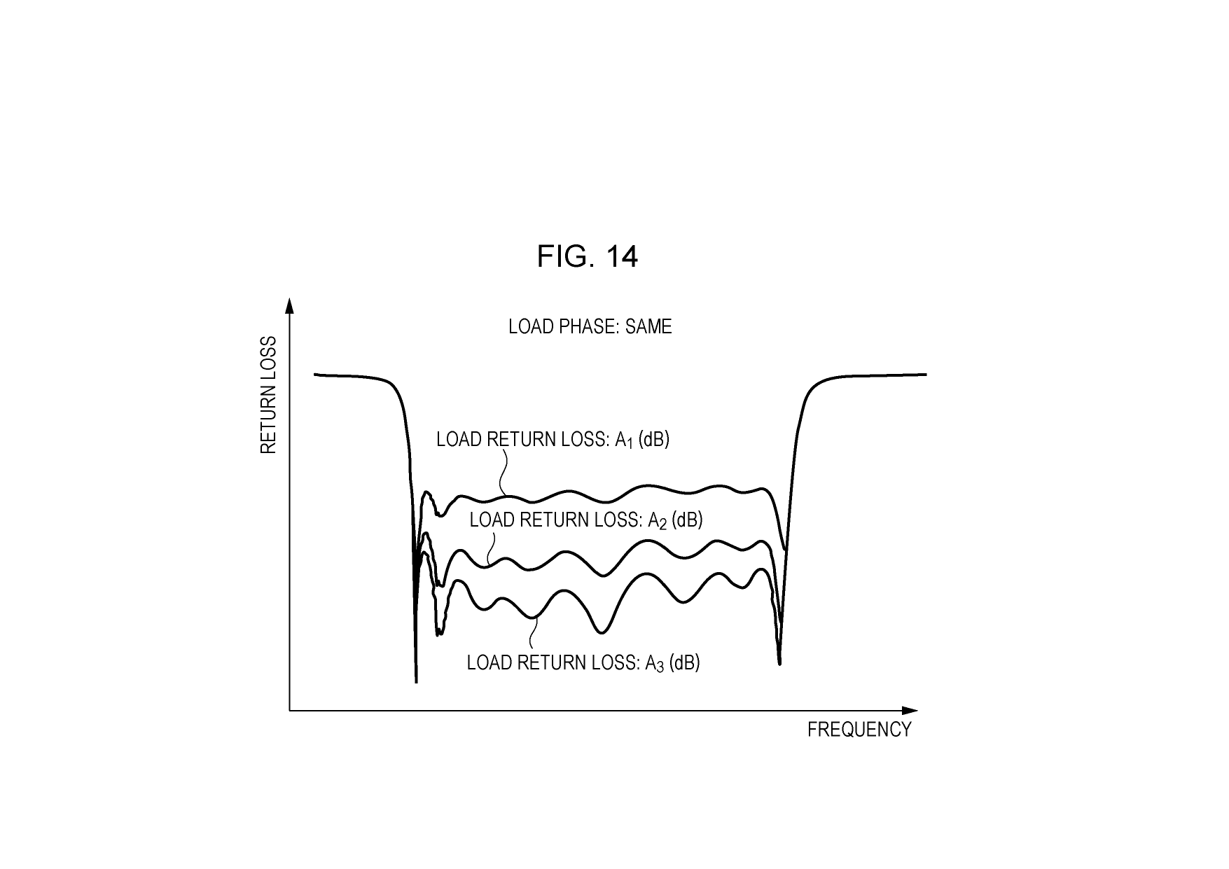

FIG. 14 is a diagram illustrating an example of the return loss characteristics of the filter. In FIG. 14, the horizontal axis represents frequency, and the vertical axis represents return loss. FIG. 14 illustrates the return loss characteristics of the filter at times when transmission loads whose load phases are the same but whose load return losses are different, namely A₁ (dB), A₂ (dB), and A₃ (dB) (A₁<A₂<A₃), respectively, are connected. As illustrated in FIG. 14, even if the load return loss is different, the ripple frequency of the return loss characteristics does not change when the load phase is the same. However, as illustrated in FIG. 14, when the load return loss is different, the level of the reflected wave and the amount of variation in ripple amplitude (the amount of variation in the level of the reflected wave) are different.

For example, in the example illustrated in FIG. 14, the level of the reflected wave detected is higher in the case of the load return loss A₁ (dB) than in the case of the load return loss A₂ (dB). In addition, the amount of variation in ripple amplitude is larger in the case of the load return loss A₂ (dB) than in the case of the load return loss A₁ (dB). That is, as the load return loss becomes larger (matching becomes more complete), the amount of variation in the level of the reflected wave becomes larger.

Thus, the amount of variation in the level of the reflected wave generated due to the ripple characteristics of the filter differs depending not only on the load phase (the phase of the reflected wave) but also on the frequency and the load return loss. Therefore, in the present example, the amounts of variation in return loss obtained by connecting reference loads are stored while being associated not only with the phases of the reflected wave but also with frequencies and load return losses.

Thus, in the present example, by storing the amounts of variation in return loss obtained in advance as correction information and by using the correction information during actual operation of the wireless communication apparatus 100, the amount of variation in the level of the reflected wave (return loss) due to the ripple characteristics may be corrected. The hardware configuration of the wireless communication apparatus 100 according to the present example will be described hereinafter.

Hardware Configuration of Wireless Communication Apparatus

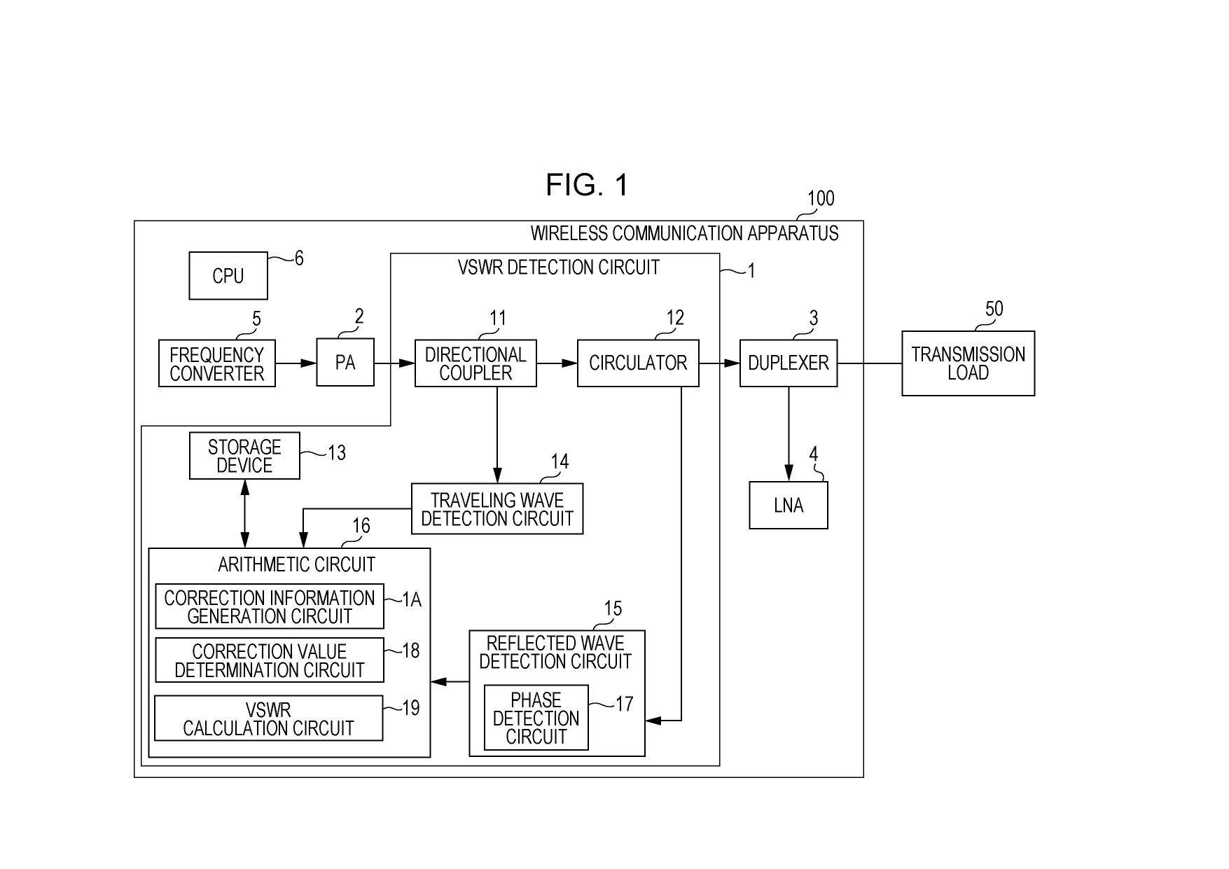

FIG. 1 is a diagram illustrating an example of the hardware configuration of the wireless communication apparatus including the VSWR detection circuit according to the first example. The wireless communication apparatus 100 according to the first example includes a VSWR detection circuit 1, a central processing unit (CPU) 6, a frequency converter 5, a power amplifier (PA) 2, a duplexer 3, and a high-frequency amplifier 4. In addition, as illustrated in FIG. 1, a transmission load 50 typified by external connection devices such as a power supply cable, a connector, and an antenna is connected to the wireless communication apparatus 100. The transmission load 50 is an example of the “load”.

Wireless Communication Apparatus

The wireless communication apparatus 100 is an apparatus that executes wireless communication with another apparatus and is a high-frequency wireless communication apparatus typified by a wireless base station or the like for mobile phones or the like.

CPU

The CPU 6 controls the entirety of the wireless communication apparatus 100 by executing a program (software) expanded to a storage device 13 or the like such that the program may be executed. In addition, the CPU 6 may control a transmission frequency by providing the frequency converter 5 with a frequency to be obtained through conversion by the frequency converter 5, that is, the transmission frequency. Here, the transmission frequency refers to the frequency of a signal transmitted from a transmission station. It is to be noted that the transmission frequency refers to the above-described frequency of the wireless communication apparatus 100.

Frequency Converter

The frequency converter 5 converts the frequency of a transmission signal input to thereto into the transmission frequency controlled (provided) by the CPU 6. That is, the frequency converter 5 sets the transmission frequency, which is the frequency of the wireless communication apparatus 100.

Power Amplifier

The power amplifier 2 amplifies the power of a wireless transmission signal (high-frequency transmission signal) output from the frequency converter 5 in order to transmit the wireless transmission signal from the antenna. The power amplifier 2 outputs the amplified wireless transmission signal to the VSWR detection circuit 1.

Duplexer

The duplexer 3 isolates signals to be signals to be transmitted and signals received through the same antenna from each other in a communication system adopting a frequency-division duplex (FDD) method. Normally, the duplexer 3 includes a band-pass filter (transmission filter) that passes only frequencies to be transmitted and a band-pass filter (reception filter) that passes only frequencies to be received. The duplexer 3 is an example of the “filter”.

High-Frequency Amplifier

The high-frequency amplifier 4 amplifies a radio wave (signal) received through the antenna without adding noise as much as possible. The high-frequency amplifier 4 outputs the amplified signal to a reception unit (not illustrated). The high-frequency amplifier 4 is typified by a low-noise amplifier (LNA) or the like.

VSWR Detection Circuit

The VSWR detection circuit 1 is a circuit that detects the VSWR by detecting a traveling wave and a reflected wave of a wireless transmission signal. The VSWR detection circuit 1 includes a directional coupler 11, a circulator 12, a traveling wave detection circuit 14, a reflected wave detection circuit 15, an arithmetic circuit 16, and the storage device 13.

Directional Coupler

The directional coupler 11 isolates a traveling wave and a reflected wave of a wireless communication signal that propagates along a transmission path from each other and detects a signal corresponding only to the power of the traveling wave or signals corresponding to the power of the traveling wave and the power of the reflected wave, respectively. The directional coupler 11 is typified, for example, by a single directional coupler having three ports. In this case, the directional coupler 11 detects and outputs a signal corresponding only to power in one direction (the power of the traveling wave). In the first example, a traveling wave port of the directional coupler 11 detects a signal corresponding to the traveling wave of the wireless transmission signal and outputs the signal to the traveling wave detection circuit 14. The directional coupler 11 is not limited to the single directional coupler, and may be a dual directional coupler having four ports, instead.

Circulator

The circulator 12 includes three or more ports (terminals) and has a characteristic that signals are output in certain directions. When the circulator 12 includes, for example, three terminals, namely Terminal 1, Terminal 2, and Terminal 3, an input of Terminal 1 is invariably output to Terminal 2, an input of Terminal 2 is invariably output to Terminal 3, and an input of Terminal 3 is invariably output to Terminal 1. Thus, the directions in which signals are output are determined in advance. Therefore, in the first example, a wireless transmission signal input from the directional coupler 11 to the circulator 12 is output to the duplexer 3. In addition, when a reflected wave generated at a mismatch point between the wireless communication apparatus 100 and the transmission load 50 has been input to the circulator 12 through the duplexer 3, the reflected wave is output to the reflected wave detection circuit 15.

Traveling Wave Detection Circuit

The traveling wave detection circuit 14 is connected to the traveling wave port of the directional coupler 11 and detects a high-frequency signal corresponding to a traveling wave output from the traveling wave port and the value of the power of the traveling wave. The detected value of the power of the traveling wave will be referred to as “the level of the traveling wave” hereinafter. The traveling wave detection circuit 14 outputs the level of the traveling wave to the arithmetic circuit 16.

Reflected Wave Detection Circuit

The reflected wave detection circuit 15 is connected to the circulator 12 and detects a high-frequency signal corresponding to the reflected wave output from the circulator 12 and the level of the reflected wave. The reflected wave detection circuit 15 outputs the level of the reflected wave to the arithmetic circuit 16. In addition, the reflected wave detection circuit 15 includes a phase detection circuit 17 as a phase detection function in order to detect the phase of the reflected wave, and outputs the detected phase of the reflected wave to the arithmetic circuit 16. The reflected wave detection circuit 15 is an example of the “detection circuit”.

Phase Detection Circuit

The phase detection circuit 17 includes a circuit configuration for detecting the phase of a reflected wave that has been detected. The phase detection circuit 17 is typified by a quadrature detection circuit. When the phase detection circuit 17 is a quadrature detection circuit, the phase detection circuit 17 multiplies a reflected wave signal by a reference signal having the frequency of the wireless communication apparatus 100 and then multiplies the reflected wave signal by a signal obtained by shifting the phase of the reference signal by 90 degrees. On the basis of these two signals obtained by the multiplication, the reflected wave detection circuit 15 detects the phase of the reflected wave. Here, the reference signal may be a signal generated by a signal generator (not illustrated) or may be a signal obtained by extracting a part of a transmission wave signal. Because the quadrature detection circuit includes the same configuration as an existing quadrature detection circuit, detailed description of the configuration of the quadrature detection circuit is omitted. In addition, in the first example, the phase detection circuit 17 is not limited to the quadrature detection circuit. For example, the phase detection circuit 17 may be a circuit that detects the phase by establishing correlation by multiplying the reflected wave signal by a part of the transmission wave signal while changing the phase of the part of the transmission wave signal, a circuit that uses a phase shifter, or the like. When the phase detection circuit 17 is configured by the quadrature detection circuit, the phase θ of the reflected wave is obtained by the following expression (3).

$$θ = {tan}^{- 1} ( \frac{Rev\_Q}{Rev\_I} ) \qquad ( 3 )$$

Rev_Q: Output power of quadrature detection circuit (phase detection circuit) (output power after multiplying reflected wave signal by reference signal whose phase has been shifted by 90 degrees)

Rev_I: Output power of quadrature detection circuit (phase detection circuit) (output power after multiplying reflected wave signal by reference signal)

When the phase detection circuit 17 is configured by the quadrature detection circuit, the level of a reflected wave (Rev) detected by the reflected wave detection circuit 15 may be obtained, for example, by the following expression (4).

Rev=A\sqrt{(Rev_{—}Q)²+(Rev_{—}I)²} (4)

A: Constant

Arithmetic Circuit

The arithmetic circuit 16 calculates the VSWR on the basis of the level of the traveling wave output from the traveling wave detection circuit 14 and the level and the phase of the reflected wave output from the reflected wave detection circuit 15. The arithmetic circuit 16 includes a correction information generation circuit 1A, a correction value determination circuit 18, and a VSWR calculation circuit 19.

Correction Information Generation Circuit

The correction information generation circuit 1A generates information (hereinafter referred to as the correction information) including correction values for return losses corresponding to a plurality of reference loads whose load return losses and load phases are known, the correction values being obtained by connecting, to the wireless communication apparatus 100, the plurality of reference loads. Here, the correction values included in the correction information are, for example, the amounts of variation in return loss, which are differences between return losses detected when the reference loads have been connected to the wireless communication apparatus 100 and the load return losses of the reference loads. In addition, the correction values are not limited to the amounts of variation in return loss, and may be return losses themselves detected when the reference loads have been connected, instead. For example, the correction information generation circuit 1A obtains the correction values X included in the correction information using the following expression (5).

X(dB)=RL₁−RL_{d} (5)

RL₁: Load return loss (dB) of reference load

RL_{d}: Return loss (dB) detected when reference load has been connected

The correction information generation circuit 1A stores the calculated amounts of variation in return loss (correction values) in the storage device 13 as the correction information while associating the amounts of variation in return loss with the phases of the reflected wave, frequencies, and load return losses.

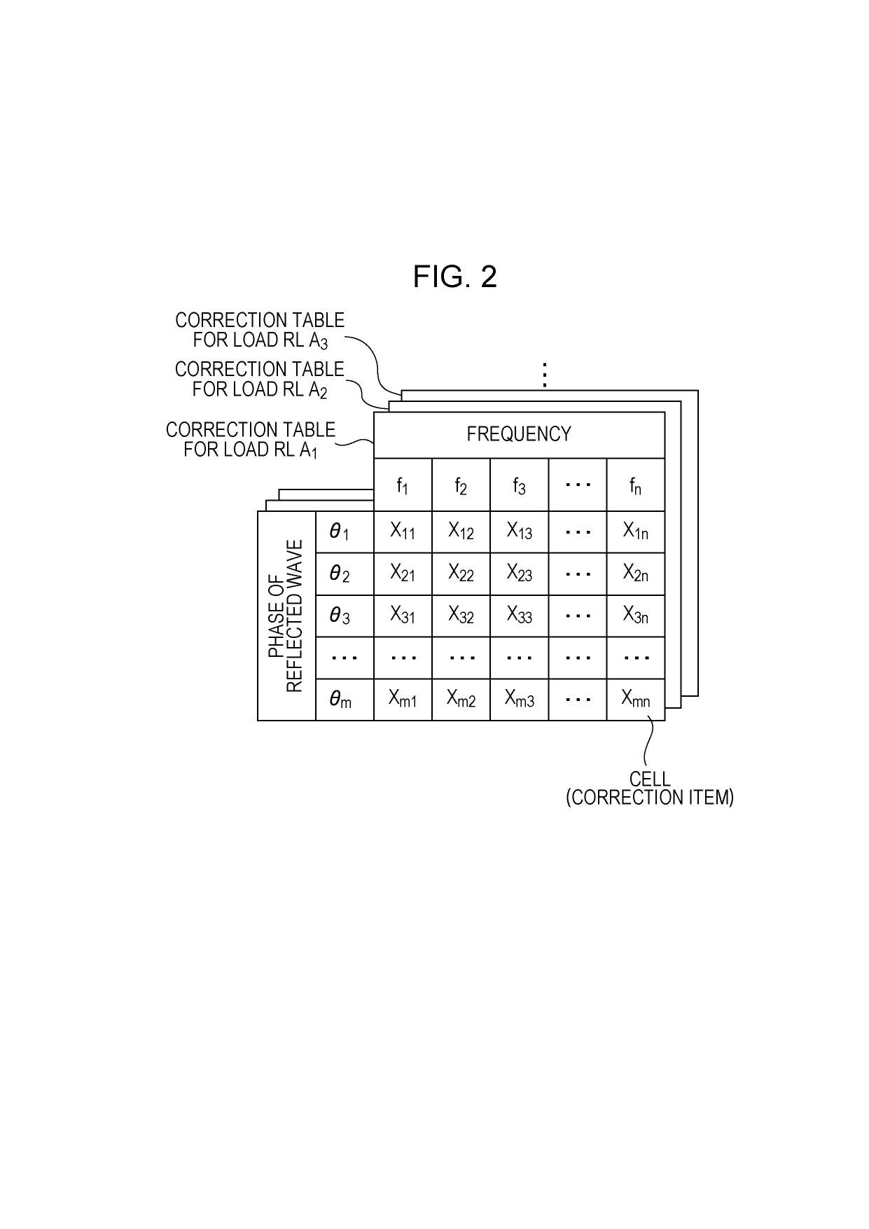

FIG. 2 is a diagram illustrating an example of the correction information (correction tables) according to the first example. As illustrated in FIG. 2, the correction information is, for example, stored in a correction table (database) for each load return loss. The correction table for each load return loss stores correction values corresponding to combinations between the phases of the reflected wave (vertical axis) and the frequencies (horizontal axis). For example, as illustrated in FIG. 2, Xₘₙ is stored as a correction value corresponding to a phase θₘ of the reflected wave and a frequency fₙ in a correction table for a load return loss A₁. In this case, a detected return loss becomes equal to the load return loss if the correction value Xₘₙ is added thereto. In the correction tables, the vertical axis may represent frequency and the horizontal axis may represent the phase of the reflected wave, instead.

The correction information generation circuit 1A may calculate a correction value that is not stored in a correction table by executing data interpolation typified by linear interpolation or the like using the correction values stored in the correction table. The data interpolation is not limited to the linear interpolation, and another type of polynomial interpolation may be performed, instead.

Correction Value Determination Circuit

The correction value determination circuit 18 determines a correction value for correcting the above-described variation in the level of the reflected wave corresponding to the load phase generated due to the ripple characteristics of the filter (the duplexer 3). That is, the correction value determination circuit 18 determines a correction value for correcting the variation in the level of the reflected wave such that a difference in the VSWR due to a difference in the load phase is generated between transmission loads whose load return losses are the same. More specifically, the correction value determination circuit 18 determines a correction value (ARL) for correcting a detected return loss (the level of the reflected wave) by referring to the correction information stored in the storage device 13 in advance on the basis of the detected return loss, the phase of the reflected wave, and the frequency. Details of a method for determining a correction value will be described in operation examples.

VSWR Calculation Circuit

The VSWR calculation circuit 19 calculates a return loss on the basis of the level of the traveling wave output from the traveling wave detection circuit 14 and the level of the reflected wave output from the reflected wave detection circuit 15. For example, the VSWR calculation circuit 19 calculates the return loss using the expression (2). In addition, when a correction value has been received from the correction value determination circuit 18, the VSWR calculation circuit 19 corrects the return loss (VSWR) using the correction value. More specifically, the VSWR calculation circuit 19 calculates the return loss on the basis of the level of the traveling wave (Fwd), the level of the reflected wave (Rev), and the correction value (ΔRL). The return loss (RL′) calculated by the VSWR calculation circuit 19 using the correction value is, for example, calculated by the following expression (6).

RL′(dB)=Fwd−Rev+ΔRL (6)

In addition, the VSWR calculation circuit 19 converts the return loss RL′ obtained by correcting the variation in the level of the reflected wave using the correction value ΔRL into a VSWR. The conversion from the return loss to the VSWR is performed using the following expression (7).

$$V S W R = \frac{{10}^{( {RL}^{′} / 20 )} + 1}{{10}^{( {RL}^{′} / 20 )} - 1} \qquad ( 7 )$$

Storage Device

The storage device 13 stores data to be processed, programs (software) to be executed by the CPU 6, and the like. The storage device 13 is typified by a read-only memory (ROM), a random-access memory (RAM), and the like. The storage device 13 stores the correction information and the like. The storage device 13 is an example of the “storage device”.

The hardware configuration of the wireless communication apparatus 100 according to the first example is as described above, but because FIG. 1 mainly illustrates a circuit (configuration) that is characteristic of the first example, the wireless communication apparatus 100 may further include a circuit other than the device (circuit) illustrated in FIG. 1.

As described above, FIG. 1 illustrates a state in actual operation in which the transmission load 50 such as an antenna has been connected to the wireless communication apparatus 100. On the other hand, before the beginning of the operation, the wireless communication apparatus 100 is connected to the reference loads in order to obtain the above-described correction information.

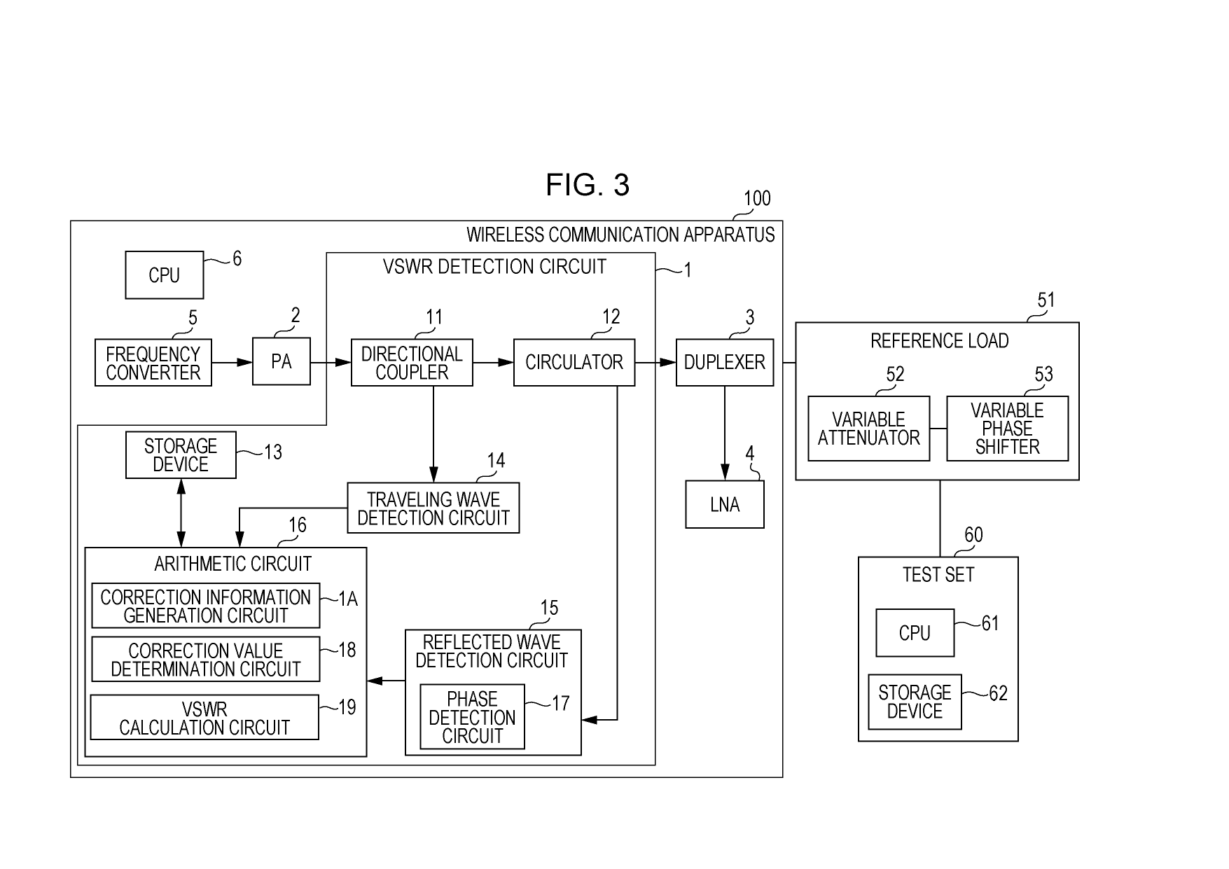

FIG. 3 is a diagram illustrating an example of a state in which a reference load is connected to the wireless communication apparatus 100 according to the first example. The wireless communication apparatus 100 illustrated in FIG. 3 has the same configuration as the wireless communication apparatus 100 illustrated in FIG. 1, and accordingly detailed description thereof is omitted. As illustrated in FIG. 3, a reference load 51, which is a dummy load of the transmission load 50, is connected to the wireless communication apparatus 100, and a test set 60 is connected to the reference load 51.

Reference Load

The reference load 51 includes a variable attenuator (hereinafter referred to as the variable ATT) 52 and a variable phase shifter 53. The variable ATT 52 adjusts the load return loss of the reference load 51 on the basis of a set value provided from the test set 60. The variable phase shifter 53 adjusts the load phase of the reference load 51 on the basis of a set value provided from the test set 60.

Test Set

The test set 60 is an information processing apparatus, that is, a computer, that controls the reference load 51, that is, the variable ATT 52 and the variable phase shifter 53. The test set 60 includes a CPU 61 and a storage device 62. The CPU 61 controls the test set 60 by executing a program expanded to the storage device 62 or the like such that the program may be executed. The storage device 62 stores programs (software) to be executed by the CPU 61, data relating to the variable ranges of the load phase and the load return loss of the reference load 51. The variable ranges of the load phase and the load return loss may be changed by a user. The storage device 62 is typified by a ROM, a RAM, and the like. The CPU 61 sets the load return loss and the load phase of the reference load 51 within the respective variable ranges by controlling the variable ATT 52 and the variable phase shifter 53, respectively.

Because FIG. 3 mainly illustrates the configurations of the wireless communication apparatus 100, the reference load 51, and the test set 60 that are characteristic of the first example, a device other than the devices illustrated in FIG. 1 may be further included.

### Operation Examples

Operation examples of the wireless communication apparatus 100 according to the first example will be described hereinafter.

### First Operation Example

### Generation of Correction Information

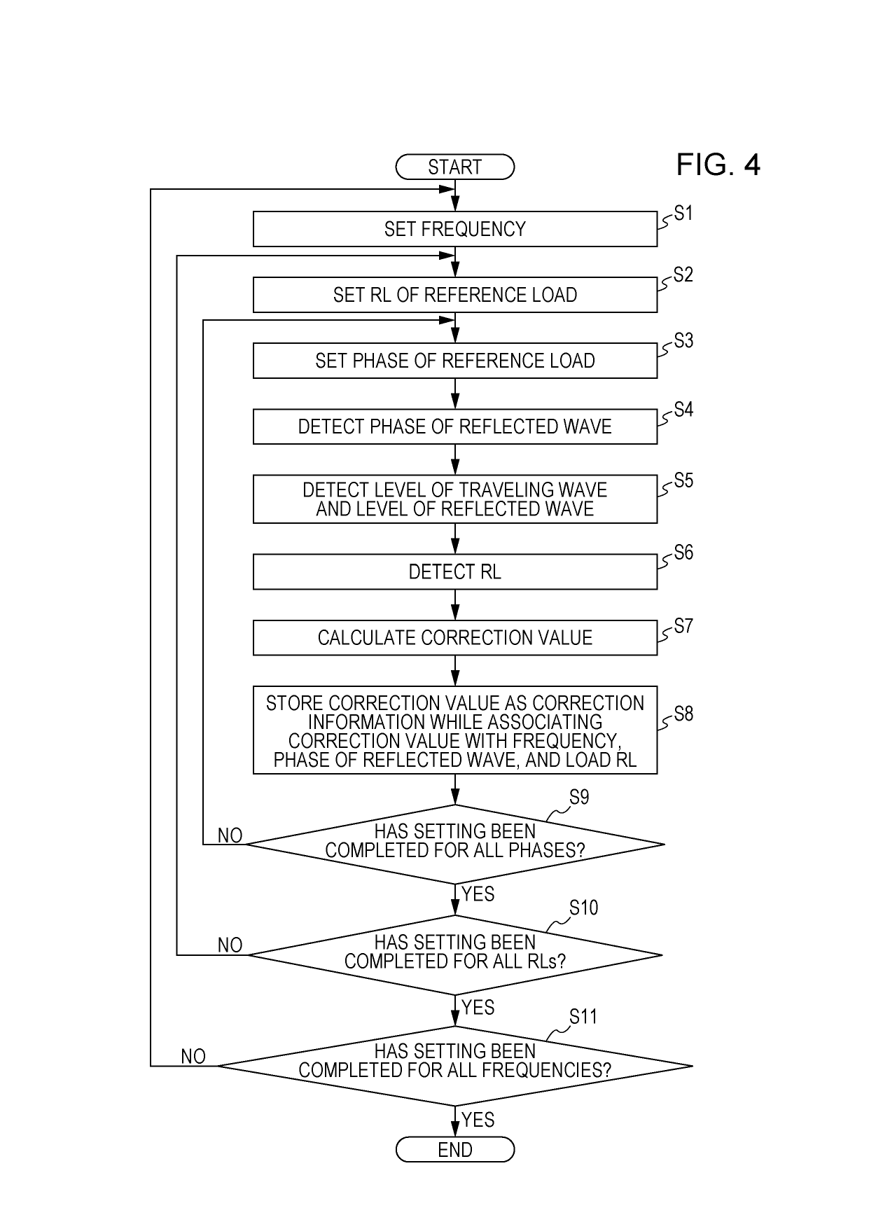

An operation for generating the correction information in the wireless communication apparatus 100 (the VSWR detection circuit 1) connected to the reference load 51 illustrated in FIG. 3 will be described hereinafter with reference to a flow illustrated FIG. 4.

FIG. 4 is a diagram illustrating an example of the generation flow of the correction information according to the first example. First, the CPU 6 of the wireless communication apparatus 100 sets the frequency (step 1; hereinafter referred to as S1). In addition, the CPU 61 of the test set 60 sets the load return loss (RL) of the reference load (S2). Furthermore, the CPU 61 of the test set 60 sets the load phase of the reference load (S3). The order of S1 to S3 may be arbitrarily changed.

After the setting of S1 to S3 is completed, the reflected wave detection circuit 15 detects the phase of the reflected wave (S4). The reflected wave detection circuit 15 detects the phase of the reflected wave by, for example, using the expression (3). In addition, the traveling wave detection circuit 14 detects the level of the traveling wave, and the reflected wave detection circuit 15 detects the level of the reflected wave (S5). The reflected wave detection circuit 15 detects the level of the reflected wave by, for example, using the expression (4). After S5, the VSWR calculation circuit 19 calculates (detects) the return loss (RL) on the basis of the level of the traveling wave and the level of the reflected wave that have been detected (S6). At this time, the VSWR calculation circuit 19 calculates the return loss by, for example, using the expression (2). The order of S4 and both S5 and S6 may be arbitrarily changed.

After the processing in S6, the correction information generation circuit 1A calculates a difference between the return loss calculated by the VSWR calculation circuit 19 and the load return loss, that is, a correction value (S7). The correction information generation circuit 1A calculates the correction value X by, for example, using the expression (5). It is to be noted that the load return loss is transmitted, for example, from the test set 60 or the reference load 51 to the wireless communication apparatus 100 and the correction information generation circuit 1A may use the load return loss for the calculation of the correction value.

After the processing in S7, the correction information generation circuit 1A associates the calculated correction value with the frequency set in S1, the phase of the reflected wave detected in S4, and the load return loss, and stores the correction value in the storage device 13 as the correction information (S8). For example, as illustrated in FIG. 2, Xₘₙ is stored in the correction table for the load return loss A₁ as a correction value corresponding to the phase θₘ of the reflected wave and the frequency fₙ. In this correction table, a cell that stores one correction value will be referred to as a correction item hereinafter.

When the processing in S8 has been completed, the CPU 61 of the test set 60 checks whether or not the setting has been ended for all load phases set within the variable range as measurement targets (S9). That is, whether or not the processing in S4 to S8 has been ended for all the load phases is checked. If the setting has not been ended for all the load phases that are the measurement targets (NO in S9), the process returns to S3, and the CPU 61 makes the setting for a load phase for which the setting has not been ended. If the setting has been ended for all the load phases (YES in S9), the CPU 61 checks whether or not the setting has been ended for all load return losses set within the variable range as measurement targets (S10). If the setting has not been ended for all the load return losses that are the measurement targets (NO in S10), the process returns to the processing in S2, and the CPU 61 makes the setting for a load return loss for which the setting has not been ended. If the setting has been ended for all the load return losses (YES in S10), the CPU 6 of the wireless communication apparatus 100 checks whether or not the setting has been ended for all frequencies set as measurement targets (S11). If the setting has not been ended for all the frequencies that are the measurement targets (NO in S11), the process returns to S1, and the CPU 6 makes the setting for a frequency for which the setting has not been ended. If the setting has been ended for all the frequencies (YES in S11), the processing flow ends.

The frequencies, the load phases, and the load return losses to be set as the measurement targets may be set by the user in advance, and set values and the like may be stored in the storage device 13, the storage device 62, or the like. In addition, although the setting is made for the frequencies, the load return losses, and the load phases in this order in the flow illustrated in FIGS. 4 (S1 to S3 and S9 to S11), the order of the setting is not limited to this, and the order in which these three parameters are set may be changed. The frequencies set in S1 may be frequencies according to the needs of the user who is using the wireless communication apparatus 100, that is, frequencies to be used by the user. In this case, the efficiency of the generation of the correction tables may be improved.

### Second Operation Example

### Calculation of VSWR

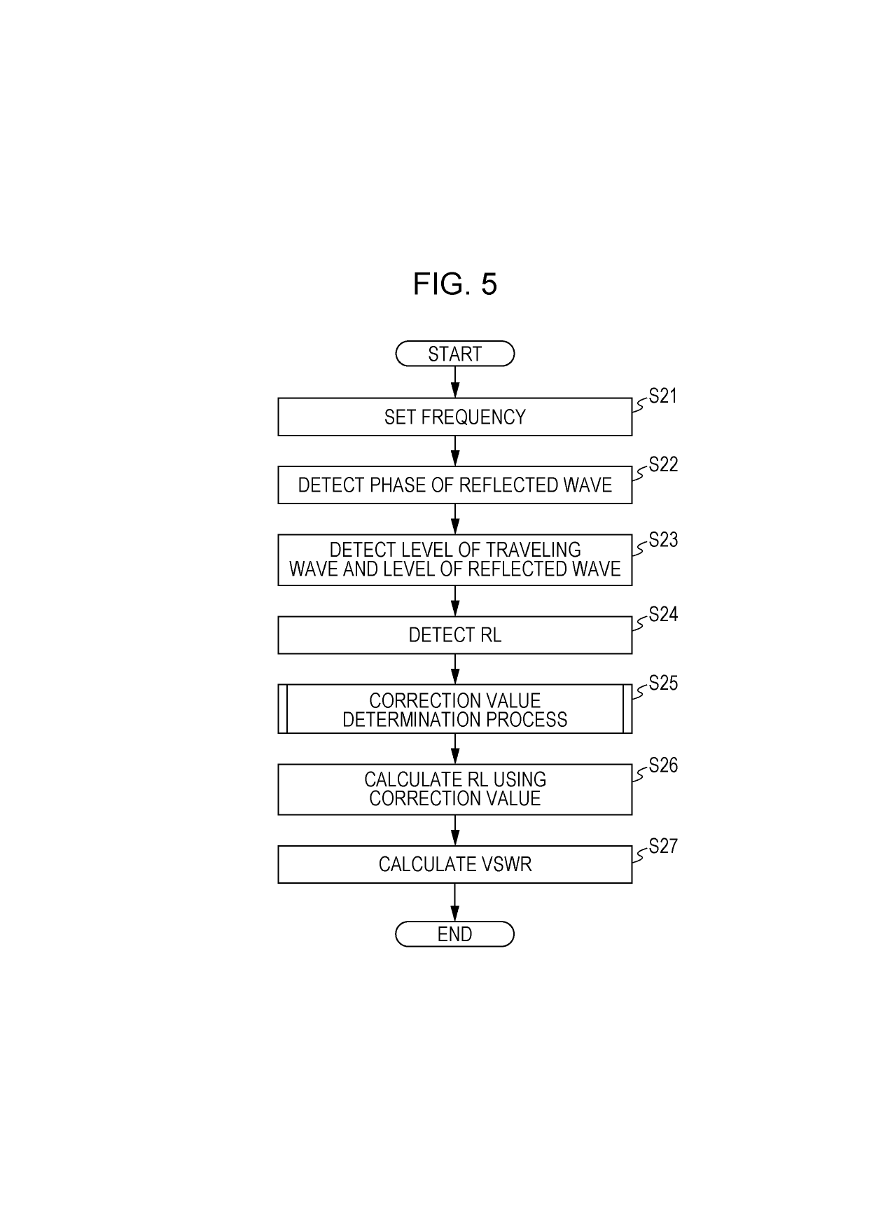

An operation for calculating the VSWR in the wireless communication apparatus 100 (the VSWR detection circuit 1) connected to the transmission load 50 illustrated in FIG. 1 will be described hereinafter with reference to a flow illustrated in FIG. 5.

FIG. 5 is a diagram illustrating an example of the calculation flow of the VSWR according to the first example. First, the CPU 6 of the wireless communication apparatus 100 sets the frequency in a state in which the transmission load 50 is connected to the wireless communication apparatus 100 (S21).

Thereafter, the wireless communication apparatus 100 transmits a wireless transmission signal to the transmission load 50, and the reflected wave detection circuit 15 detects the phase of the reflected wave (S22). The reflected wave detection circuit 15 detects the phase of the reflected wave by, for example, using the expression (3). In addition, the traveling wave detection circuit 14 detects the level of the traveling wave, and the reflected wave detection circuit 15 detects the level of the reflected wave (S23). The reflected wave detection circuit 15 detects the level of the reflected wave by, for example, using the expression (4). After S23, the VSWR calculation circuit 19 calculates (detects) the return loss (RL) on the basis of the level of the traveling wave and the level of the reflected wave that have been detected (S24). At this time, the VSWR calculation circuit 19 calculates the return loss by, for example, using the expression (2). The order of S22 and both S23 and S24 may be arbitrarily changed.

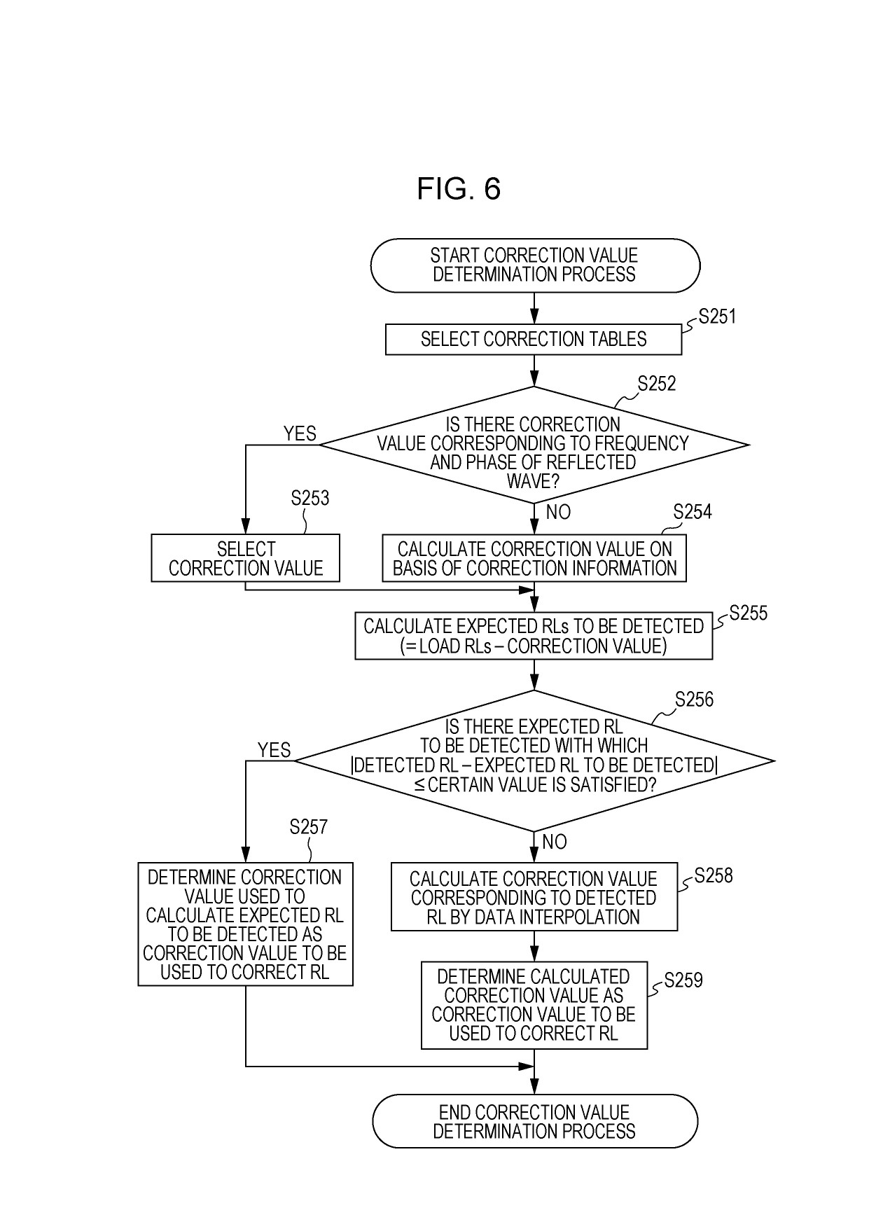

After the processing in S24, the correction value determination circuit 18 executes a process (a correction value determination process) for determining the correction value (ΔRL) for correcting the return loss (the level of the reflected level) (S25). Details of the correction value determination process will be described later with reference to FIG. 6. The correction value determination circuit 18 outputs the determined correction value to the VSWR calculation circuit 19.

When the correction value has been calculated and output in S25, the VSWR calculation circuit 19 corrects the return loss using the correction value (S26). More specifically, the VSWR calculation circuit 19 calculates the return loss (RU) using the level of the traveling wave and the level of the reflected wave detected in S23 and the correction value determined in S25. The VSWR calculation circuit 19 corrects the return loss by, for example, using the expression (6).

Thereafter, the VSWR calculation circuit 19 calculates the VSWR by converting the return loss calculated in S26 into the VSWR (S27). The VSWR calculation circuit 19 converts the return loss into the VSWR by, for example, using the expression (7). After the processing in S27, the processing flow ends.

### Third Operation Example

### Correction Value Determination Process

An operation for executing the correction value determination process in the wireless communication apparatus 100 connected to the transmission load 50 illustrated in FIG. 1 will be described hereinafter with reference to a flow illustrated in FIG. 6.

FIG. 6 is a diagram illustrating an example of the flow of the correction value determination process according to the first example. The correction value determination circuit 18 selects correction tables to be referred to in order to determine the correction value on the basis of the return loss (hereinafter referred to as the detected RL) detected in S24 illustrated in FIG. 5 (S251). More specifically, the correction value determination circuit 18 selects correction tables for load return losses that might be connected to the wireless communication apparatus 100 at a time when the detected RL is obtained. For example, the correction value determination circuit 18 selects correction tables for load return losses included in a range (a range of the detected RL±a certain value ΔR1) having a certain width from the value of the detected RL. The certain width (the certain value ΔR1) may be changed by the user.

After the processing in S251, the correction value determination circuit 18 checks whether or not there is a correction item corresponding to a combination between the frequency set in S21 and the phase of the reflected wave detected in S22 illustrated in FIG. 5 in the correction tables selected in S251 (S252). If there is such a correction item (YES in S252), the correction value determination circuit 18 selects a correction value stored in the correction item (S253). When the correction value has been selected in S253, the process proceeds to processing in S255.

If there is not such a correction item (NO in S252), the correction information generation circuit 1A calculates a correction value corresponding to the combination between the frequency set in S21 and the phase of the reflected wave detected in S22 illustrated in FIG. 5 on the basis of the correction tables selected in S251 (S254). The correction information generation circuit 1A calculates the correction value corresponding to the combination between the frequency and the phase of the reflected wave by, for example, performing data interpolation using the correction values stored in the selected correction tables. Details of the method of the data interpolation will be described in a processing example, which will be described later. After the correction value is calculated in S254, the process proceeds to the processing in S255.

After S253 or S254, the correction value determination circuit 18 calculates a return loss (hereinafter referred to as the expected RL to be detected) that is expected to be detected in the case of the frequency set in S21 and the phase of the reflected wave detected in S22 illustrated in FIG. 5 for each correction table (load return loss) (S255). More specifically, the correction value determination circuit 18 subtracts the correction value selected in S253 or the correction value calculated in S254 from the load return loss for each correction table, and uses the value obtained by the subtraction as the expected RL to be detected.

It is to be noted that the above-described processing in S252 to S255 illustrated in FIG. 6 is performed for all the correction tables selected in S251. When the processing in S252 to S255 has been performed for all the correction tables selected in S251, the process proceeds to processing in S256.

The correction value determination circuit 18 checks whether or not there is an expected RL to be detected with which a difference between the detected RL obtained in S24 illustrated in FIG. 5 and the expected RL to be detected calculated in S254 becomes smaller than or equal to a certain value ΔR2 (S256). More specifically, the correction value determination circuit 18 checks whether or not there is an expected RL to be detected with which the absolute value (|detected RL−expected RL to be detected|) of the difference between the detected RL and the expected RL to be detected becomes smaller than or equal to the certain value. The certain value ΔR2 may be changed by the user and may be stored in the storage device 13 in advance.

If there is an expected RL to be detected with which the absolute value of the difference becomes smaller than or equal to the certain value (YES in S256), the correction value determination circuit 18 determines the correction value used to calculate the expected RL to be detected as the correction value ΔRL to be used to correct the return loss (S257). When there are a plurality of expected RLs to be detected with which the absolute value of the difference becomes smaller than or equal to the certain value in S256, a correction value used to calculate the expected RL to be detected with which the absolute value of the difference becomes the smallest may be determined as the correction value to be used to correct the return loss. When the correction value to be used to correct the return loss has been determined in S257, the processing flow illustrated in FIG. 6 ends.

If there is no expected RL to be detected with which the absolute value of the difference becomes smaller than or equal to the certain value (NO in S256), the correction information generation circuit 1A calculates a correction value corresponding to the detected RL on the basis of correction values used to calculate an expected RL to be detected that is the closest to the detected RL and an expected RL to be detected that is the second closest to the detected RL (S258). Here, as described above, the filter has a characteristic that the ripple frequency of the return loss characteristics thereof does not change even when the load return loss is different, and the amount of variation in return loss becomes larger as the return loss becomes larger. Therefore, the correction value corresponding to the detected RL may be obtained by performing data interpolation using the correction values corresponding to other return losses. Accordingly, the correction information generation circuit 1A may calculate the correction value corresponding to the detected RL by, for example, executing the data interpolation using the correction values used to calculate the expected RL to be detected that is the closest to the detected RL and the expected RL to be detected that is the second closest to the detected RL. Details of the method of the data interpolation will be described in the processing example, which will be described later.

After the processing in S258, the correction value determination circuit 18 determines the correction value calculated in S258 as the correction value to be used to correct the return loss (S259). When the correction value to be used to correct the return loss has been determined in S259, the processing flow illustrated in FIG. 6 ends.

### Processing Example

### Correction Value Determination Process

An example of the correction value determination process illustrated in FIG. 6 will be described hereinafter with reference to FIG. 2.

In this processing example, the correction value determination process will be described while the frequency set in S21 illustrated in FIG. 5 is denoted by fₓ, the phase of the reflected wave detected in S22 is denoted by θₓ, and the return loss (the detected RL) detected in S24 is denoted by RLₓ.

First, the correction value determination circuit 18 selects correction tables for load return losses that might be connected to the wireless communication apparatus 100 at a time when the detected RL is obtained, that is, the operation of the correction value determination circuit 18 corresponds to S251 illustrated in FIG. 6. For example, the correction value determination circuit 18 selects correction tables for load return losses included in the range of the detected RL (RLₓ)±the certain value (ΔR1). For example, in the case of RLₓ−ΔR1≦A₁≦RLₓ+ΔR1, RLₓ−ΔR1≦A₂≦RLₓ+ΔR1, and RLₓ−ΔR1≦A₃≦RLₓ+ΔR1, the correction value determination circuit 18 selects correction tables for the load return losses A₁, A₂, and A₃ from among the plurality of correction tables.

Next, the correction value determination circuit 18 checks whether or not there is a correction item corresponding to a combination between the frequency fₓ and the phase θₓ of the reflected wave in the selected correction tables (hereinafter referred to as the correction tables A₁, A₂, and A₃) for the load return losses A₁, A₂, and A₃, that is, the operation of the correction value determination circuit 18 corresponds to S251 illustrated in FIG. 6. When the frequency fₓ is f₁<fₓ<f₂ and the phase θₓ of the reflected wave is θ₁<θₓ<θ₂, a correction item corresponding to the combination between the frequency fₓ and the phase θₓ of the reflected wave does not exist in any of the correction tables A₁, A₂, and A₃ illustrated in FIG. 2. Therefore, the correction information generation circuit 1A calculates, for each correction table, a correction value corresponding to the combination between the frequency fₓ and the phase θₓ of the reflected wave by executing data interpolation using the correction values stored in the correction table, which corresponds to S254 illustrated in FIG. 6. As an example of the data interpolation, linear interpolation will be described hereinafter.

The method of the linear interpolation in the correction table A₁ illustrated in FIG. 2 will be described. The correction information generation circuit 1A reads correction values stored in correction items corresponding to combinations between frequencies (f₁ and f₂) that precede and follow the frequency fₓ and phases (θ₁ and θ₂) that precede and follow the phase θₓ of the reflected wave. That is, the correction information generation circuit 1A reads correction values X₁₁, X₁₂, X₂₁, and X₂₂. The correction value when the phase of the reflected wave is θ₁ is X₁₁ in the case of the frequency f₁ and X₁₂ in the case of the frequency f₂. Therefore, when the phase of the reflected wave is θ₁ and the linear interpolation of correction values is to be performed between the frequency f₁ and the frequency f₂, for example, the following expression (8) is used to obtain a correction value subjected to the linear interpolation.

$$α ( dB ) = \frac{{X}_{11} - {X}_{12}}{{f}_{1} - {f}_{2}} * {f}_{x} + \frac{{f}_{1} * {X}_{12} - {f}_{2} * {X}_{11}}{{f}_{1} - {f}_{2}} \qquad ( 8 )$$

α: Correction value corresponding to load return loss A₁, phase θ₁ of reflected wave, and frequency fₓ

Similarly, the correction value when the phase of the reflected wave is θ₂ is X₂₁ in the case of the frequency f₁ and X₂₂ in the case of the frequency f₂. Therefore, when the phase of the reflected wave is θ₂ and the linear interpolation of correction values is to be performed between the frequency f₁ and the frequency f₂, for example, the following expression (9) is used to obtain a correction value subjected to the linear interpolation.

$$β ( dB ) = \frac{{X}_{21} - {X}_{22}}{{f}_{1} - {f}_{2}} * {f}_{x} + \frac{{f}_{1} * {X}_{22} - {f}_{2} * {X}_{21}}{{f}_{1} - {f}_{2}} \qquad ( 9 )$$

β: Correction value corresponding to load return loss A₁, phase θ₂ of reflected wave, and frequency fₓ

Thus, the correction value corresponding to the combination between the load return loss A₁, the frequency fₓ, and the phase θ₁ of the reflected wave is α, and the correction value corresponding to the load return loss A₁, the frequency fₓ, and the phase θ₂ of the reflected wave is β. Therefore, when the linear interpolation is to be performed between the phase θ₁ of the reflected wave and the phase θ₂ of the reflected wave, the following expression (10) is used to obtain a correction value subjected to the linear interpolation.

$$Y ( dB ) = \frac{α - β}{{θ}_{1} - {θ}_{2}} * {θ}_{x} + \frac{β * {θ}_{1} - α * {θ}_{2}}{{θ}_{1} - {θ}_{2}} \qquad ( 10 )$$

Y: Correction value corresponding to load return loss A₁, phase θₓ of reflected wave, and frequency fₓ

Thus, the correction information generation circuit 1A may calculate a correction value corresponding to the combination between the frequency fₓ and the phase θₓ in the correction table A₁ by using the expressions (8) to (10). In addition, as in the correction table A₁, the correction information generation circuit 1A may calculate correction values corresponding to the combination between the frequency fₓ and the phase θₓ of the reflected wave in the correction tables A₂ and A₃. The correction values corresponding to the combination between the frequency fₓ and the phase θₓ of the reflected wave calculated in the correction tables A₁, A₂, and A₃ will be referred to as Y_{A1}, Y_{A2}, and Y_{A3}, respectively.

When the correction values (Y_{A1}, Y_{A2}, and Y_{A3}) corresponding to the combination between the frequency fₓ and the phase θₓ have been calculated, the correction value determination circuit 18 calculates an expected RL to be detected for each table at a time when the frequency is fₓ and the phase of the reflected wave is θₓ, the operation of the correction value determination circuit 18 corresponds to S255 illustrated in FIG. 6. More specifically, in the correction table A₁, the correction value determination circuit 18 subtracts the correction value Y_{A1} from the load return loss A₁ and determines a value obtained by the subtraction as the expected RL to be detected (RL_{EA1}). Similarly, in the correction tables A₂ and A₃, the correction value determination circuit 18 subtracts the correction values Y_{A2} and Y_{A3} from the load return losses A₂ and A₃, respectively, and determines values obtained by the subtraction as the expected RLs to be detected (RL_{EA2} and RL_{EA3}, respectively).

The correction value determination circuit 18 checks whether or not there is an expected RL to be detected with which the absolute values of differences between the detected RL (RLₓ) and the expected RLs to be detected (RL_{EA1}, RL_{EA2}, and RL_{EA3}) are smaller than or equal to the certain value (ΔR2) (corresponds to S256 illustrated in FIG. 6). In this processing example, it is assumed that the certain value ΔR2<|RLₓ-RL_{EA1}|<|RLₓ-RL_{EA2}|<|RLₓ-RL_{EA3}| in the following description.

In this case, because there is no expected RL to be detected with which the differences between the detected RL and the expected RLs to be detected are smaller than or equal to the certain value, the correction information generation circuit 1A executes data interpolation using correction values used to calculate an expected RL to be detected that is the closest to the detected RL and an expected RL to be detected that is the second closest to the detected RL (corresponds to S258 illustrated in FIG. 6). In this processing example, the data interpolation of correction values is performed using the correction values (Y_{A1} and Y_{A2}) used to calculate the expected RL to be detected (RL_{EA1}) that is the closest to the detected RL and the expected RL to be detected (RL_{EA2}) that is the second closest to the detected RL, and the correction value corresponding to the detected RL is obtained. For example, the following expression is used to obtain the correction value corresponding to the detected RL.

$$Z ( dB ) = \frac{{Y}_{A 1} - {Y}_{A 2}}{R {L}_{EA 1} - R {L}_{EA 2}} * R {L}_{x} + \frac{{Y}_{A 2} * R {L}_{EA 1} - {Y}_{A 1} * R {L}_{EA 2}}{R {L}_{EA 1} - R {L}_{EA 2}} \qquad ( 11 )$$

Z: Correction value corresponding to detected return loss RLₓ, phase θₓ of reflected wave, and frequency fₓ

Thus, the correction information generation circuit 1A may calculate the correction value corresponding to the combination between the detected return loss RLₓ, the frequency fₓ, and the phase θₓ of the reflected wave by using the expression (11).

First Modification: Reference Load

In the first example, as illustrated in FIG. 3, the reference load 51 that includes the variable ATT 52 and the variable phase shifter 53 as a reference load and that may electrically set the load return loss and the load phase has been described as an example. However, the present example is not limited to this reference load, and a plurality of reference loads including different load return losses and different load phases may be connected to the wireless communication apparatus 100, instead.

Second Modification: Method for Selecting Tables

In the first example (the third operation example), in S251 illustrated in FIG. 6, the method for selecting correction tables for load return losses included in the range of the detected RL±the certain value (ΔR1) has been described as an example as a method for selecting correction tables to be referred to in order to determine the correction values. However, the present example is not limited to this method, and the following method may be used, instead.

As described above, by subtracting the correction values included in a correction table generated for each load return loss from a load return loss corresponding to the correction table, expected RLs to be detected at a corresponding frequency in a corresponding phase of the reflected wave may be calculated. Therefore, a maximum value and a minimum value of the expected RLs to be detected in each correction table (load return loss) may be obtained on the basis of a maximum value and a minimum value of the correction values included in a correction table generated for each load return loss. That is, a maximum expected RL to be detected and a minimum expected RL to be detected, that is, the range of the detected RL, may be obtained in each correction table (load return loss).

By storing the range of the detected RL (from the minimum expected RL to be detected to the maximum expected RL to be detected) in advance while associating the range of the detected RL with each correction table when the correction table is generated, it becomes possible to select correction tables that might include the detected RL. That is, when measurement has been completed for all the frequencies set in S11 illustrated in FIG. 4, the correction information generation circuit 1A calculates the minimum expected RL to be detected and the maximum expected RL to be detected in each correction table, and the minimum expected RL to be detected and the maximum expected RL to be detected are stored while being associated with a corresponding correction table. In doing so, the correction value determination circuit 18 may check in S251 illustrated in FIG. 6 whether or not the detected RL obtained in S24 illustrated in FIG. 5 is included in the ranges of the detected RL in the correction tables, and a correction table that has been judged to include the value of the detected RL may be selected.

Third Modification: Storage of Correction Values Obtained by Data Interpolation

In the first example, as illustrated in FIG. 4, a method for storing, in the correction tables, only correction values calculated by measuring return losses on the basis of frequencies, load phases, and load return losses that have been set has been described as an example of the method for generating the correction tables. However, the present example is not limited to this method. For example, a correction value corresponding to a load (a load phase and a load return loss) that has not been measured may be calculated by data interpolation using the correction values calculated for the measured loads and may be stored in a correction table in advance.

Fourth Modification: Correction Information (Correction Expression)

In the first example, as illustrated in FIG. 2, the correction information is stored in the correction tables. However, the present example is not limited to this, and the correction information may be stored as a correction expression.

As described above, the amount of variation in return loss (the level of the reflected wave) corresponding to the load phase depends on the phase of the reflected wave, the frequency, and the load return loss. Here, the detected RL obtained in S6 illustrated in FIG. 4 is obtained by summing the load return loss and the amount of variation in return loss. Therefore, it may be said that the amount of variation in return loss corresponding to the load phase depends on the phase of the reflected wave, the frequency, and the detected RL. Accordingly, the correction value Xₘₙ for the return loss may be expressed as a function (Xₘₙ=f (phase of reflected wave)+g (frequency)+h (detected RL); f, g, and h denote functions) of the phase of the reflected wave, the frequency, and the detected RL. Therefore, this function of Xₘₙ may be the correction expression, that is, the correction information. The function of the correction value Xₘₙ may be generated on the basis of each correction value obtained by setting a frequency, a load return loss, and a load phase in FIG. 4.

When the correction expression is used as the correction information, the correction value determination circuit 18 does not execute the correction value determination process illustrated in FIG. 6 and calculates (determines) a correction value by inputting a frequency, a phase of the reflected wave, and a detected RL to the above correction expression.

Fifth Modification: Hardware Configuration

In the first example, as illustrated in FIG. 1, the arithmetic circuit 16 executes various arithmetic processes such as a process for calculating the VSWR on the basis of the level of the traveling wave, the level of the reflected wave, and the phase of the reflected wave. However, the present example is not limited to a case in which the circuit executes various arithmetic processes. For example, various arithmetic processes may be performed by executing programs stored in a storage device such as the storage device 13 using the CPU 6. In addition, the detection of the level of the reflected wave and the phase of the reflected wave by the reflected wave detection circuit 15 may be realized by executing a program using the CPU 6, instead.

### Second Example

### Correction Values Stored in Correction Tables

Although a correction value, which is the amount of variation in return loss, is stored in a correction table in the first example, the present embodiment is not limited to this, and a return loss itself detected during generation of correction information may be stored in a correction table. More specifically, in S8 of the generation flow of the correction information illustrated in FIG. 4, the return loss detected in S6 is stored instead of storing a correction value as correction information. The return loss detected in S6 corresponds to the above-described expected RL to be detected. A correction value determination process when the return loss detected in S6 has been stored in a correction table will be described hereinafter. A second example is the same as the first example except for the correction values to be stored in the correction tables and the correction value determination process, and accordingly detailed description thereof is omitted. The first to fifth modifications may be adopted in the second example.

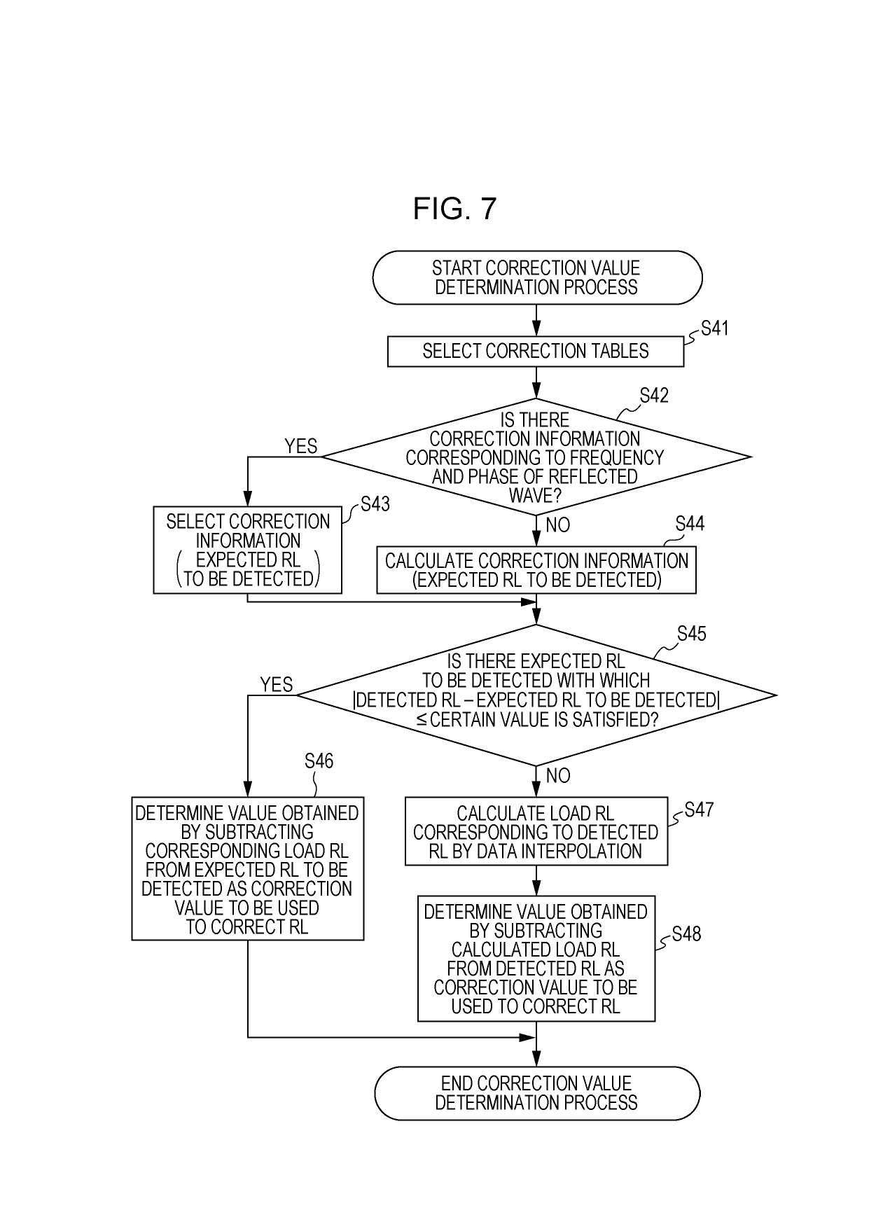

FIG. 7 is a diagram illustrating an example of the flow of a correction value determination process according to the second example. The correction value determination circuit 18 selects correction tables to be referred to in order to determine the correction value on the basis of the detected RL obtained in S24 illustrated in FIG. 5 (S41). The processing in S41 is the same as the processing in S251 illustrated in FIG. 6, and accordingly detailed description thereof is omitted.

After the processing in S41, the correction value determination circuit 18 checks whether or not there is a correction item corresponding to a combination between the frequency set in S21 and the phase of the reflected wave detected in S22 illustrated in FIG. 5 in the selected correction tables (S42). If there is such a correction item (YES in S42), the correction value determination circuit 18 selects correction information (an expected RL to be detected) stored in the correction item (S43). After the correction value is selected in S43, the process proceeds to processing in S45.

If there is not such a correction item (NO in S42), the correction information generation circuit 1A calculates correction information (an expected RL to be detected) corresponding to the combination between the frequency and the phase of the reflected wave by executing data interpolation or the like on the basis of the correction information stored in the correction tables selected in S41 (S44). The method of the data interpolation in S44 is the same as the method of the data interpolation in S254 illustrated in FIG. 6, and accordingly detailed description thereof is omitted. When the correction information has been calculated in S44, the process proceeds to the processing in S45.

It is to be noted that the above-described processing in S42 to S44 illustrated in FIG. 7 is executed for all the correction tables selected in S41. When the processing in S42 to S44 has been executed for the correction tables selected in S41, the process proceeds to the processing in S45.

The correction value determination circuit 18 checks whether or not there is an expected RL to be detected with which a difference between the detected RL obtained in S24 illustrated in FIG. 5 and the correction information (the expected RL to be detected) selected in S43 or calculated in S44 becomes smaller than or equal to the certain value (ΔR2) (S45). More specifically, the correction value determination circuit 18 checks whether or not there is an expected RL to be detected with which the absolute value (|detected RL—expected RL to be detected|) of the difference between the detected RL and the expected RL to be detected becomes smaller than or equal to the certain value.

If there is an expected RL to be detected with which the absolute value of the difference becomes smaller than or equal to the certain value (YES in S45), the correction value determination circuit 18 determines a value obtained by subtracting a load return loss corresponding to the expected RL to be detected (the correction information) from the expected RL to be detected as a correction value to be used to correct the return loss (S46). When there are a plurality of expected RLs to be detected with which the absolute value of the difference becomes smaller than or equal to the certain value in S46, a value obtained by subtracting a load return loss corresponding to an expected RL to be detected with which the absolute value of the difference becomes the smallest from the expected RL to be detected as the correction value to be used to correct the return loss. When the correction value to be used to correct the return loss has been determined in S46, the processing flow illustrated in FIG. 7 ends.

If there is no expected RL to be detected with which the absolute value of the difference becomes smaller than or equal to the certain value (NO in S45), the correction information generation circuit 1A calculates a load return loss corresponding to the detected RL by data interpolation (S47). More specifically, the correction information generation circuit 1A calculates the load return loss corresponding to the detected RL by executing the data interpolation using the load return losses corresponding to an expected RL to be detected that is the closest to the detected RL and an expected RL to be detected that is the second closest to the detected RL.

After the processing in S47, the correction value determination circuit 18 determines a value obtained by subtracting the load return loss calculated in S47 from the detected RL as the correction value to be used to correct the return loss (S48). When the correction value to be used to correct the return loss has been determined in S48, the processing flow illustrated in FIG. 7 ends.

Although the value obtained by subtracting the load return loss from the expected RL to be detected or the detected RL is determined as the correction value to be used to correct the return loss in S46 or S48 illustrated in FIG. 7, the present example is not limited to this. For example, the processing in S46 and S48 is not performed in FIG. 7 and the load return loss corresponding to the expected RL to be detected with which the difference has been judged in S45 to be smaller than or equal to the certain value or the load return loss calculated in S47 is output to the VSWR calculation circuit 19. The VSWR calculation circuit 19 then may determine the obtained load return loss as the corrected return loss (R′) calculated in S26 illustrated in FIG. 5.

### Third Example

### Items in Correction Tables (Detected RLs)

In the first example, as illustrated in FIG. 2, the correction table for each load return loss has been described as a correction table as an example. However, the present embodiment is not limited to this type of correction table, and a correction table for each return loss detected during generation of correction information may be used. A method for generating correction tables and a correction value determination process when each correction table is a correction tables for each return loss detected during the generation of the correction information will be described hereinafter. A third example is the same as the first example except for the method for generating correction tables and the correction value determination process, and accordingly detailed description thereof is omitted. The first modification and the third to fifth modifications may be adopted in the third example.

Method for Generating Correction Tables

When each correction table is a correction table for each return loss detected during the generation of the correction information, a correction value is stored as the correction information in S8 of the generation flow of the correction information illustrated in FIG. 4 while being associated with the frequency, the phase of the reflected wave, and the return loss calculated in S6. For example, correction tables for detected return losses B₁, B₂, B₃, and the like are generated instead of the correction tables for the load return losses A₁, A₂, A₃, and the like illustrated in FIG. 2. When the correction tables for detected return losses are generated, correction values corresponding to only combinations between phases of the reflected wave and frequencies detected during the measurement of the detected return losses are stored in the correction tables. Therefore, the correction values corresponding to all the frequencies and all the phases of the reflected wave (e.g., θ₁ to θₘ and f₁ to fₙ illustrated in FIG. 2) in the correction tables might not be stored. In this case, correction values corresponding to combinations between frequencies and phases of the reflected wave that are not stored may be obtained by data interpolation using correction values corresponding to combinations between frequencies and phases of the reflected wave that precede and follow the frequencies and the phases of the reflected wave that are not stored. The processing in the other steps illustrated in FIG. 4 is the same as that in the first example, and accordingly detailed description thereof is omitted.

Correction Value Determination Process

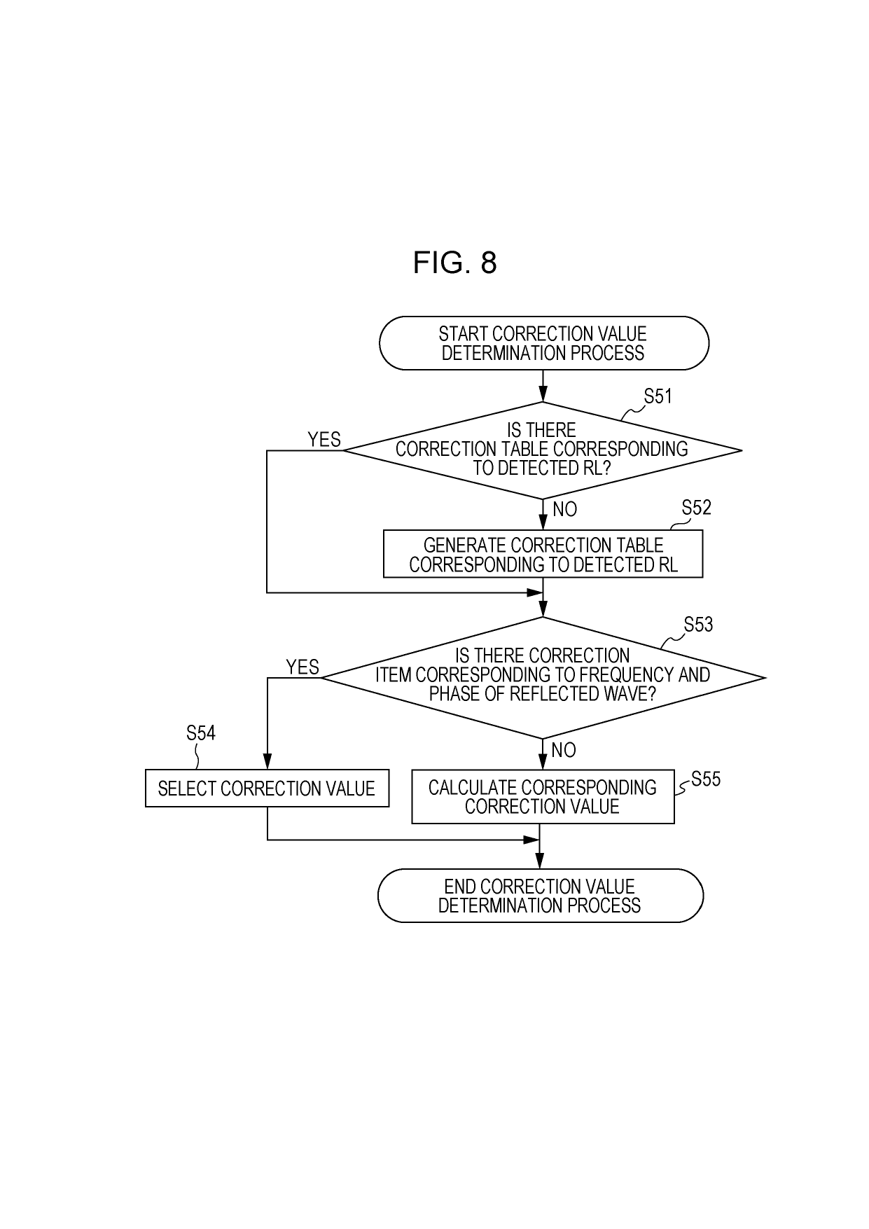

FIG. 8 is a diagram illustrating an example of the flow of a correction value determination process according to the third example. The correction value determination circuit 18 checks whether or not there is a correction table corresponding to the detected RL obtained in S24 illustrated in FIG. 5 (S51). More specifically, the correction value determination circuit 18 compares the detected RL and a return loss relating to each correction table (the return loss detected in S6 illustrated in FIG. 4) and checks whether or not the absolute value of a difference between the two is smaller than or equal to a certain value (ΔR3). The certain value may be changed by the user and may be stored in the storage device 13 or the like.

If there is a correction table corresponding to the detected RL (YES in S51), the process proceeds to processing in S53. On the other hand, if there is no correction table corresponding to the detected RL (NO in S51), the correction information generation circuit 1A executes data interpolation to generate a correction table corresponding to the detected RL (S52). After the processing in S52, the process proceeds to the processing in S53.

The correction value determination circuit 18 checks whether or not there is a correction item corresponding to a combination between the frequency set in S21 and the phase of the reflected wave detected in S22 illustrated in FIG. 5 in the selected correction table (S53). If there is a correction item corresponding to the frequency and the phase of the reflected wave in the correction table (YES in S53), a correction value stored in the correction item is selected (S54). After the processing in S54, the processing flow ends.

On the other hand, if there is no correction item corresponding to the frequency and the phase of the reflected wave in the correction table (NO in S53), the correction information generation circuit 1A executes data interpolation to calculate a correction value corresponding to the frequency and the phase of the reflected wave (S55). For example, the correction information generation circuit 1A executes the data interpolation using the method of the data interpolation described in the above processing example. After the processing in S55, the processing flow ends.

Although a correction table corresponding to the detected RL is generated in S52 illustrated in FIG. 8, the present example is not limited to a case in which a correction table that stores correction values corresponding to all the frequencies and all the phases of the reflected wave is generated. For example, a correction table that stores only a correction value corresponding to the frequency set in S21 and the phase of the reflected wave detected in S22 illustrated in FIG. 5 or correction values corresponding to frequencies and phases of the reflected wave within a certain range including these values may be generated.

In addition, although a correction table for each return loss detected in S6 illustrated in FIG. 4 is generated in the above example, since a correction table is generated for each detected return loss in this method, numerous correction tables might be undesirably generated. Therefore, in order to reduce this possibility, a correction table for a certain return loss or a plurality of certain return losses may be generated by performing data interpolation using a plurality of return losses detected and correction values. For example, when return losses detected at the same frequency in the same phase of the reflected wave are 18 dB, 22 dB, and 27 dB, correction values when the detected return losses are 20 dB and 25 dB are calculated by performing linear interpolation on correction values calculated for these return losses. In doing so, correction tables for the detected return losses (expected RLs to be detected) of 20 dB and 25 dB may be generated. A correction value determination process in this case is the same as the correction value determination process illustrated in FIG. 8, and accordingly detailed description thereof is omitted.

### Fourth Example

### Configuration of Correction Tables and Correction Value Determination Process

In the first example, as illustrated in FIG. 2, a correction table for each load return loss has been described as a correction table as an example. However, the present embodiment is not limited to this type of correction table, and a correction table for each frequency or a correction table for each phase of the reflected wave may be used, instead. A correction value determination process when a correction table for each frequency is used and a correction value determination process when a correction table for each phase of the reflected wave will be described hereinafter as a first method and a second method, respectively. A fourth example is the same as the first example except for the configurations of the correction tables and the correction value determination processes described in the first and second methods, and accordingly detailed description thereof is omitted. In addition, the first modification and the third to fifth modifications may be adopted in the fourth example.

First Method: Correction Table for Each Phase of Reflected Wave

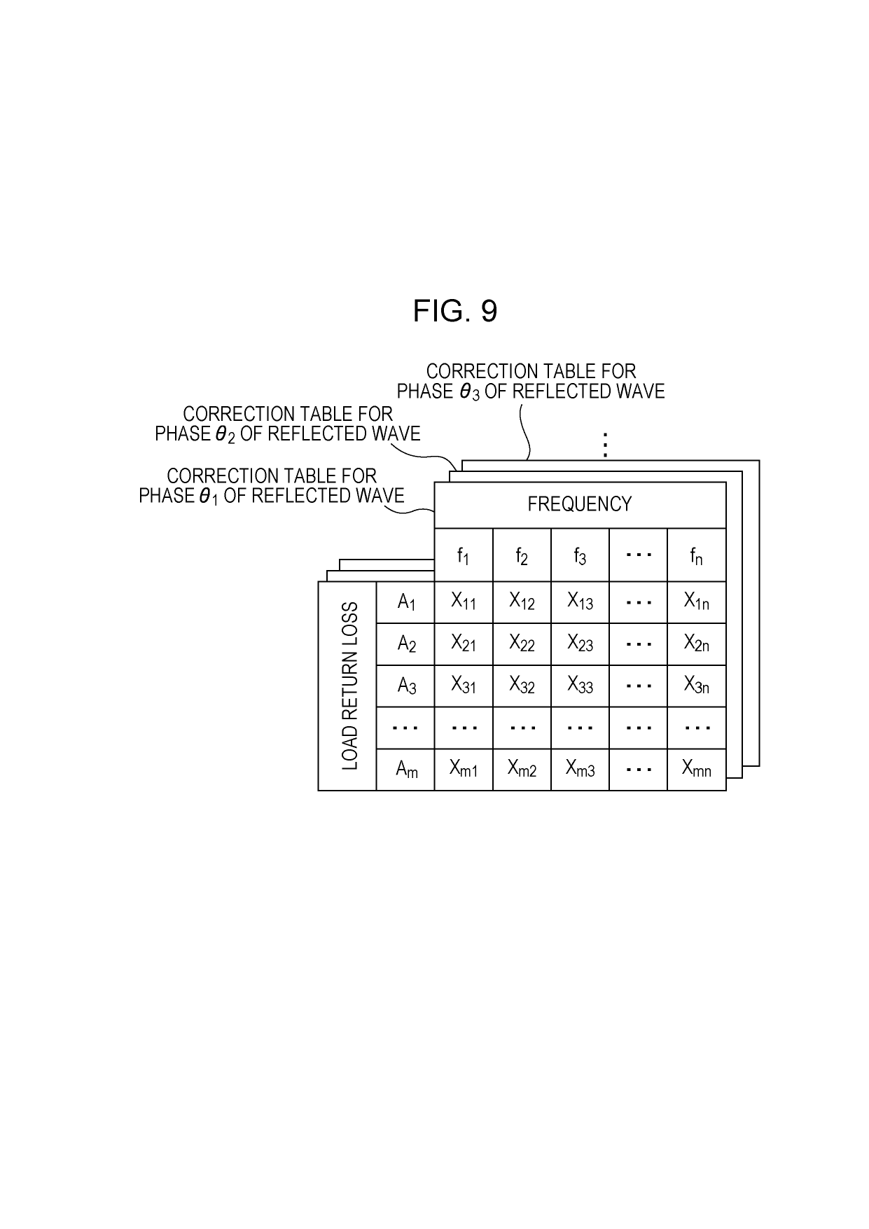

FIG. 9 is a diagram illustrating an example of correction information (correction tables) according to the fourth example. FIG. 9 illustrates correction tables for phases of the reflected wave. In a correction table for each phase of the reflected wave, correction values corresponding to combinations between load return losses (the vertical axis) and frequencies (the horizontal axis) are stored. For example, as illustrated in FIG. 9, in a correction table for a phase θ₁ of the reflected wave, Xₘₙ is stored as a correction value corresponding to a load return loss Aₘ and a frequency fₙ is stored. It is to be noted that, in the correction tables, the vertical axis may represent frequency, and the horizontal axis may represent load return loss. The method of a correction value determination process when a correction table for each phase of the reflected wave illustrated in FIG. 9 is used as a correction table will be described hereinafter.

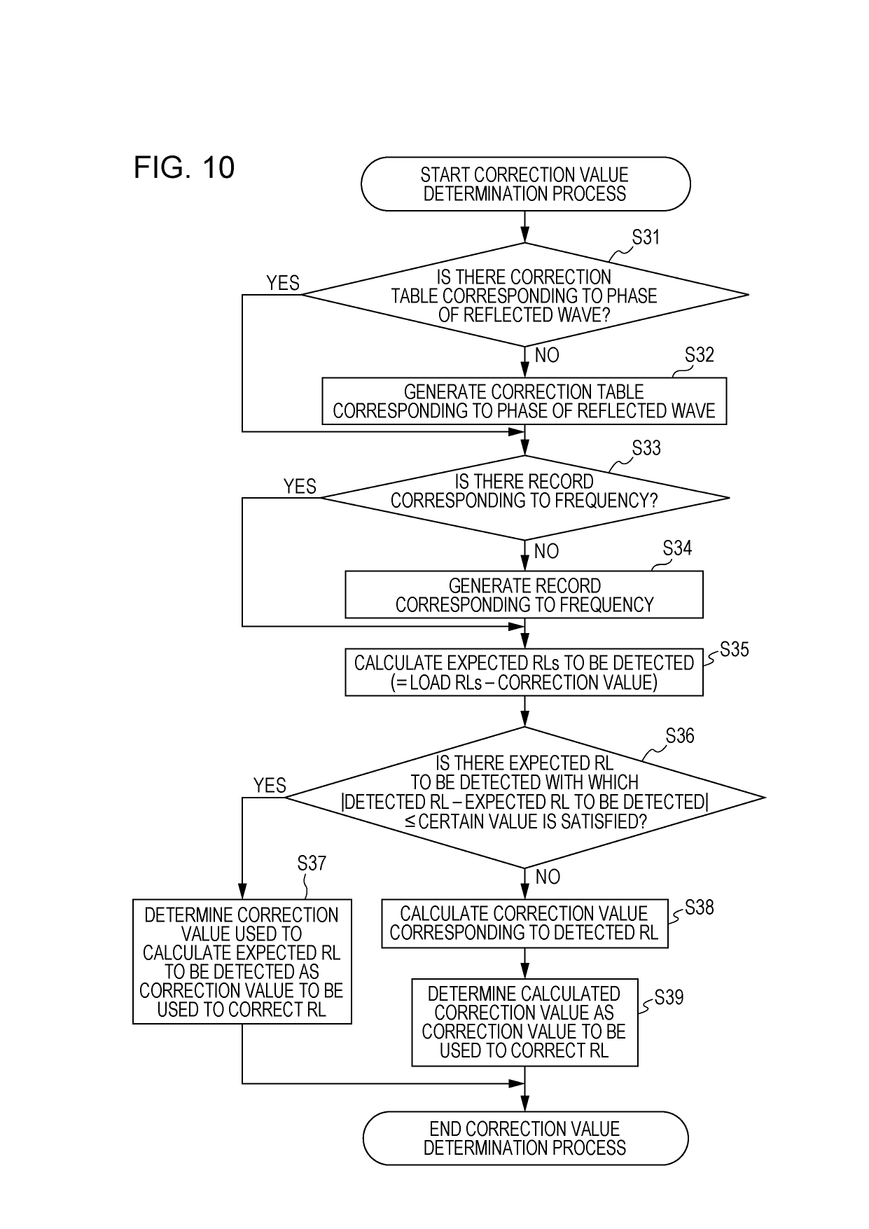

FIG. 10 is a diagram illustrating an example of the flow of a correction value determination process according to the fourth example. The correction value determination process when a correction table for each phase of the reflected wave will be described with reference to FIG. 10. The correction value determination circuit 18 checks whether or not there is a correction table corresponding to the phase of the reflected wave detected in S22 illustrated in FIG. 5 (S31). If there is a correction table corresponding to the detected phase of the reflected wave (YES in S31), the process proceeds to processing in S33. On the other hand, if there is no correction table corresponding to the detected phase of the reflected wave (NO in S31), the correction information generation circuit 1A generates the correction table for the detected phase of the reflected wave by executing data interpolation (S32). For example, the correction information generation circuit 1A executes the data interpolation using correction tables for phases that precede and follow the detected phase of the reflected wave and that are the closest to the detected phase of the reflected wave. After the processing in S32, the process proceeds to the processing in S33.

The correction value determination circuit 18 checks whether or not there is a correction item regarding the frequency set in S21 illustrated in FIG. 5, that is, a record regarding the set frequency, in the selected correction table (S33). If there is a record regarding the set frequency in the selected correction table (YES in S33), the process proceeds to processing in S35. If there is no record regarding the set frequency in the selected correction table (NO in S33), the correction information generation circuit 1A generates the record regarding the set frequency by executing data interpolation (S34). For example, the correction information generation circuit 1A executes the data interpolation using records (correction values) regarding frequencies that precede and follow the set frequency and that are the closest to the set frequency. After the processing in S34, the process proceeds to the processing in S35.

The correction value determination circuit 18 calculates an expected RL to be detected for each record regarding the set frequency in the selected correction table, that is, each of the plurality of correction values corresponding to the set frequency in the selected correction table (S35). More specifically, the correction value determination circuit 18 subtracts each of the plurality of correction values corresponding to the set frequency from the corresponding load return loss and determines a value obtained by the subtraction as the expected RL to be detected.

The correction value determination circuit 18 checks whether or not there is an expected RL to be detected with which a difference between the detected RL obtained in S24 illustrated in FIG. 5 and the expected RL to be detected calculated in S35 becomes smaller than or equal to the certain value (ΔR2) (S36). If there is an expected RL to be detected with which the difference becomes smaller than or equal to the certain value (YES in S36), the correction value determination circuit 18 determines the correction value used to calculate the expected RL to be detected as a correction value to be used to correct the return loss (S37). If there is a plurality of expected RLs to be detected with which the absolute value of the difference becomes smaller than or equal to the certain value in S36, a correction value used to calculated an expected RL to be detected with which the absolute value of the difference becomes the smallest is determined as the correction value to be used to correct the return loss. When the correction value to be used to correct the return loss has been determined in S37, the processing flow illustrated in FIG. 10 ends.

If there is no expected RL to be detected with which the difference becomes smaller than or equal to the certain value (NO in S36), the correction information generation circuit 1A calculates a correction value corresponding to the detected RL on the basis of an expected RL to be detected that is the closest to the detected RL, an expected RL to be detected that is the second closest to the detected RL, and correction values used to calculate these return losses (S38). More specifically, the correction information generation circuit 1A calculates the correction value corresponding to the detected RL by executing data interpolation using the correction values used to calculate the expected RL to be detected that is the closest to the detected RL and the expected RL to be detected that is the second closest to the detected RL.

After the processing in S38, the correction value determination circuit 18 determines the correction value calculated in S38 as the correction value to be used to correct the return loss (S39). When the correction value to be used to correct the return loss has been determined in S39, the processing flow illustrated in FIG. 10 ends.

Although a correction table corresponding to the detected phase of the reflected wave is generated in S32 illustrated in FIG. 10, the present example is not limited to a case in which a correction table that stores correction values corresponding to all the frequencies and all the load return losses is generated. For example, a correction table that stores only correction values corresponding to the frequency set in S21 illustrated in FIG. 5 or a certain range of frequencies including the set frequency may be generated, instead. Alternatively, a correction table that stores only correction values corresponding to a certain range of load return losses may be generated on the basis of the return loss detected in S24 illustrated in FIG. 5. Similarly, in S34 illustrated in FIG. 10, a record that stores only correction values corresponding to the certain range of load return losses and that corresponds to the set frequency may be generated.

Second Method: Correction Table for Each Frequency

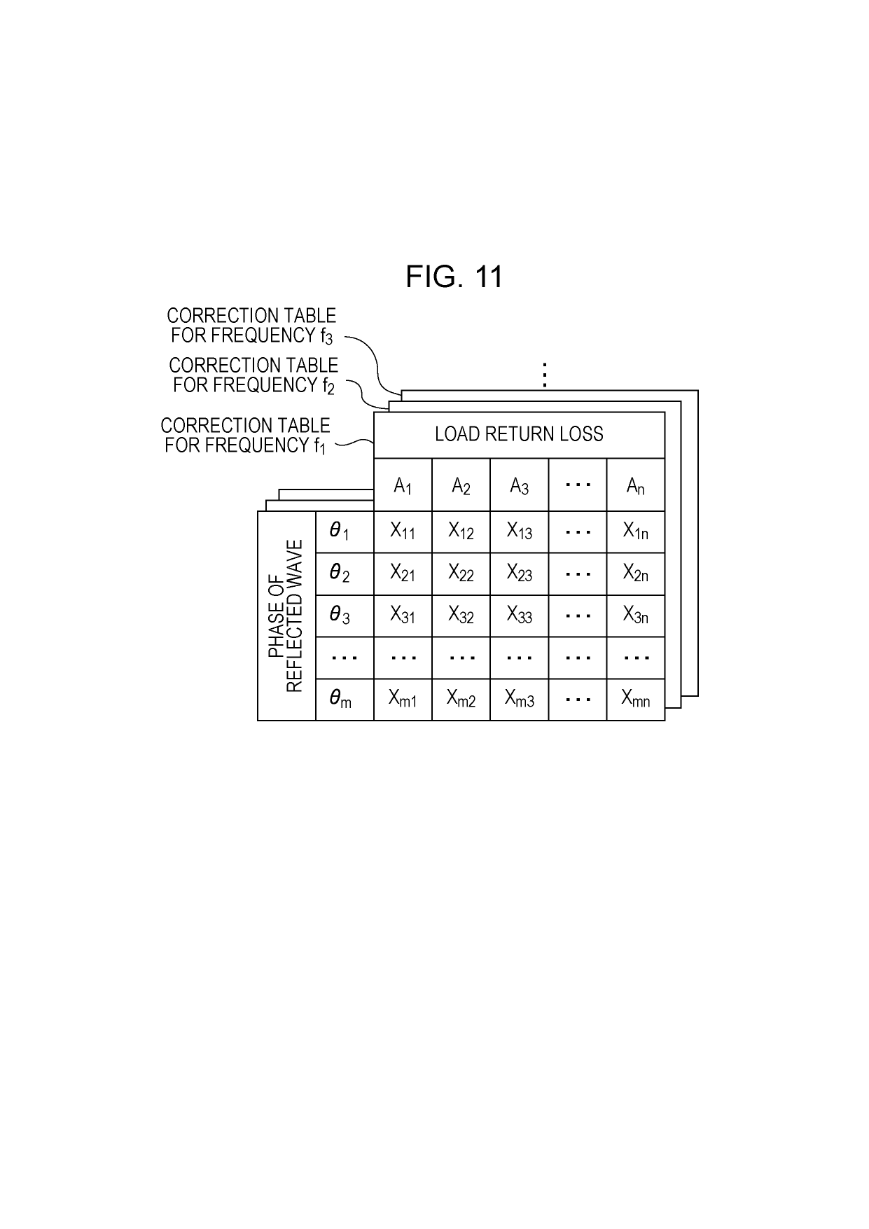

FIG. 11 is a diagram illustrating an example of the correction information (correction tables) according to the fourth embodiment. FIG. 11 illustrates a correction table for each frequency. In a correction table for each frequency, correction values corresponding to combinations between phases of the reflected wave (vertical axis) and load return losses (horizontal axis) are stored. For example, as illustrated in FIG. 11, Xₘₙ is stored in a correction table for a frequency f₁ as a correction value corresponding to a phase θₘ of the reflected wave and a load return loss Aₙ. It is to be noted that, in the correction tables, the vertical axis may represent load return loss, and the horizontal axis may represent the phase of the reflected wave. The method of a correction value determination process when a correction table for each frequency is used as the correction table may be the same as the method of the correction value determination process when a correction table for each phase of the reflected wave illustrated in FIG. 10 is used. In the method of the correction value determination process when a correction table for each frequency, the term “frequency” in the correction value determination process illustrated in FIG. 10 is replaced by “phase of the reflected wave” and the term “phase of the reflected wave” in the correction value determination process illustrated in FIG. 10 is replaced by “frequency”.

### Fifth Example

### Method for Generating Correction Tables

In the first example, the correction information is generated by connecting the reference load 51 to the wireless communication apparatus 100. When there are a plurality of wireless communication apparatuses 100 in this case, because the characteristics of a filter included in each wireless communication apparatus 100 are not the same due to errors in manufacture and the like, correction information is to be generated for each wireless communication apparatus 100. Therefore, an operation load for generating the correction information undesirably becomes large.

In order to reduce the operation load, correction information may be generated in advance for a certain reference filter and correction information for the other filters may be generated using this correction information as a reference instead of generating correction information for each wireless communication apparatus 100. For example, differences in characteristics between the reference filter and the filters (the other filters) included in the other wireless communication apparatuses 100 are obtained in advance, and the correction information for the reference filter is corrected on the basis of the differences in characteristics, in order to generate the correction information for the other filters. Here, the characteristics of the filters are typified by an S parameter. According to this method, the generation of the correction information by connecting the reference loads may be omitted in all the wireless communication apparatuses 100. In addition, it is sufficient if the reference filter is a filter that serves as a reference for generating correction information, and the user (one who generates the correction information) may arbitrarily select the reference filter from among the plurality of filters. The fifth example is the same as the first example except for the method for generating correction information. In addition, the first to fifth modifications may be adopted in the fifth example.

According to the present embodiment, the VSWR detection circuit 1 stores correction information for correcting the amount of variation in the level of a reflected wave (return loss) generated due to the ripple characteristics of the duplexer 3 while the reference load 51 is connected to the wireless communication apparatus 100. Therefore, the VSWR detection circuit 1 may correct, using the correction information stored in advance, the level of the reflected wave (return loss) detected after the reflected wave has passed through the duplexer 3 during the operation of the wireless communication apparatus 100. Thus, in the present embodiment, it is possible to correct a variation in the level of the reflected wave (return loss) detected after the reflected wave has passed through the duplexer 3, the variation being generated due to the ripple characteristics. Therefore, a variation in the level generated due to the ripple characteristics may be suppressed in a wireless communication apparatus 100 that includes a filter in a later stage of the reflected wave detection circuit 15, and accordingly the wireless communication apparatus 100 may include a configuration in which the filter is included in a later stage of the reflected wave detection circuit 15.

In addition, as described above, the ripple characteristics (the amount of variation in return loss) of the filter depend on the load phase (the phase of the reflected wave). Therefore, by storing the correspondence between the load phase (the phase of the reflected wave) and the ripple characteristics, that is, for example, the correspondence between the phase of the reflected wave and the amount of variation in return loss, in advance, the amount of variation in return loss corresponding to the phase of the reflected wave detected during the operation of the wireless communication apparatus 100 may be obtained on the basis of the correspondence. In the present embodiment, the VSWR detection circuit 1 detects the phase of the reflected wave in the reflected wave detection circuit 15 in addition to the level of the reflected wave. Therefore, by referring to the correction information on the basis of the detected phase of the reflected wave, the VSWR detection circuit 1 may calculate a correction value for correcting the detected level of the reflected wave corresponding to the detected phase of the reflected wave.

In addition, according to the present embodiment, correction information regarding the filter used in each wireless communication apparatus 100 may be generated on the basis of a difference in characteristics between a reference filter and the filter used in each wireless communication apparatus 100 using correction information generated for the reference filter in advance. Therefore, according to the present embodiment, it is possible to reduce the operation load for connecting the reference load 51 to each wireless communication apparatus 100 to generate the correction information.

In addition, in the present embodiment, the following advantageous effects may be produced compared to the above-described related art. When a circulator is provided at an output end (the previous stage of an antenna) of a wireless communication apparatus as in the case of Japanese Laid-open Patent Publication No. 2002-43957 (FIGS. 1 and 2), there is a problem in that a distorted signal generated in the circulator is emitted from the antenna as a spurious signal. This is because a circulator is normally a nonlinear device and therefore distortion is generated. In order to suppress the distortion, a circulator for power that is sufficiently large relative to the transmission power of the wireless communication apparatus may be used, but, in this case, there is a problem in that inconvenience is caused in cost, size, and weight. In the present embodiment, as illustrated in FIG. 1, since the duplexer 3 is provided in a later stage of the circulator 12, a distorted signal generated in the circulator 12 may be suppressed, if not removed, by the duplexer 3. Therefore, the problem that inconvenience is caused in cost, size, and weight may be solved.

In addition, similarly, when the circulator is provided at the output end of the wireless communication apparatus as in Japanese Laid-open Patent Publication No. 2002-43957, a circulator that covers a wide range of frequencies, namely from the band of transmission waves to the band of reception waves, is used in order to pass both the transmission waves and the reception waves. Therefore, there is a problem in that the type of circulator to be used is limited. In the present embodiment, as illustrated in FIG. 1, the reception waves are output to the high-frequency amplifier 4 without passing through the circulator 12 because of the duplexer 3 provided in a later stage of the circulator 12. Therefore, since the circulator 12 passes only the transmission waves, a circulator that covers only the band of the transmission waves may be used as the circulator 12, and the circulator 12 is not limited to a circulator that covers a wide range of frequencies. Therefore, the problem that the type of circulator to be used is limited may be solved.

In addition, when the transmission waves pass through various circuits such as a circulator, a directional coupler, and a reception band-pass filter as in Japanese Laid-open Patent Publication No. 2002-43957 (FIG. 2), there is a problem in that the losses of the reception waves become large, thereby decreasing the reception sensitivity. In the present embodiment, as illustrated in FIG. 1, since the reception waves pass through only a reception filter (the duplexer 3), the losses of the reception waves may be reduced, thereby improving the reception sensitivity of the reception waves.

Here, when the channel width is small as indicated by a region T illustrated in FIG. 12, the effect of the ripple characteristics of the filter becomes large compared to when the channel width is large as indicated by a region S. This is because when the channel width is large, the amount of variation in the level of the reflected wave is offset by a portion in which the amount of variation is large and a portion in which the amount of variation is small, but when the channel width is small, the amount of variation in the level of the reflected wave is not offset. According to the present embodiment, by correcting the amount of variation in the level of the reflected wave (return loss) generated due to the ripple characteristics of the filter on the basis of the correction information, the effect of the ripple characteristics may be reduced. That is, according to the present embodiment, the detection accuracy of the VSWR may be improved even in a narrow band. Therefore, even in the wireless communication apparatus 100 whose channel width is large, the VSWR may be detected in a narrow band obtained by intentionally extracting a part of the channel width. Accordingly, according to the present embodiment, the VSWR may be detected in a certain frequency band in the channel width that is not disturbed by an illegal wireless station or the like, thereby making it possible to suppress error detection of the VSWR due to disturbance by the illegal wireless station or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A voltage standing wave ratio detection circuit comprising:
a filter that limits a frequency of a transmission wave;
a detection circuit that detects a reflected wave, the reflected wave being formed by reflection of the transmission wave with a load connected in a later stage of the filter and having passed through the filter;
a storage device that stores correction information on the basis of a reference reflected wave generated when a reference load has been arranged in the later stage of the filter; and
an arithmetic circuit that corrects a voltage standing wave ratio calculated on the basis of the reflected wave and the transmission wave through correcting the reflected wave in accordance with the correction information.

2. The voltage standing wave ratio detection circuit according to claim 1,
wherein the detection circuit detects a level of the reflected wave and a phase of the reflected wave, and
wherein the arithmetic circuit includes
a correction value calculation circuit that calculates a correction value for correcting the level of the reflected wave detected by the detection circuit on the basis of the phase of the reflected wave detected by the detection circuit and the correction information, and
a voltage standing wave ratio calculation circuit that calculates a voltage standing wave ratio on the basis of the reflected wave detected by the detection circuit, the transmission wave, and the calculated correction value.

3. A voltage standing wave ratio detection circuit comprising:
a filter that limits a frequency of a transmission wave;
a detection circuit that detects a reflected wave of the transmission wave, the transmission wave being reflected from a load connected in a later stage of the filter and having passed through the filter;
a storage device that stores correction information corresponding to the filter generated on the basis of correction information based on a reflected wave generated at a time when a reference load has been connected in a later stage of a reference filter and a difference in characteristics between the reference filter and the filter; and
an arithmetic circuit that corrects a voltage standing wave ratio calculated on the basis of the reflected wave and the transmission wave by correcting the reflected wave detected by the detection circuit on the basis of the correction information.

4. A method for detecting a voltage standing wave ratio using a wireless communication apparatus, the method comprising:
limiting a frequency of a transmission wave using a filter;
detecting a reflected wave of the transmission wave that has been reflected from a load connected in a later stage of the filter and that has passed through the filter;
storing correction information based on a reflected wave generated at a time when a reference load has been connected in a later stage of the filter; and
correcting the voltage standing wave ratio calculated on the basis of the reflected wave and the transmission wave by correcting the detected reflected wave on the basis of the correction information.

5. A method for detecting a voltage standing wave ratio using a wireless communication apparatus, the method comprising:
limiting a frequency of a transmission wave using a filter;
detecting a reflected wave of the transmission wave that has been reflected from a load connected in a later stage of the filter and that has passed through the filter;
storing correction information corresponding to the filter generated on the basis of correction information based on a reflected wave generated at a time when a reference load has been connected in a later stage of a reference filter and a difference in characteristics between the reference filter and the filter; and
correcting the voltage standing wave ratio calculated on the basis of the reflected wave and the transmission wave by correcting the detected reflected wave on the basis of the correction information.
